(19) United States
(12) Patent Application Publication
(10) Pub. No.: US 2023/0117557 A1
(43) Pub. Date: Apr. 20, 2023

(54) COMMODITY REGISTRATION DEVICE AND COMMODITY REGISTRATION PROGRAM

(71) Applicant: TOSHIBA TEC KABUSHIKI KAISHA, Tokyo (JP)

(72) Inventors: Hikaru KOMIYAMA, Yokohama Kanagawa (JP); Yumiko OKUMA, Koganei Tokyo (JP)

(21) Appl. No.: 17/960,737

(22) Filed: Oct. 5, 2022

(30) Foreign Application Priority Data
Oct. 15, 2021 (JP) 2021-169462
Apr. 18, 2022 (JP) 2022-068399

(51) Int. Cl. G06Q 20/38; G06Q 30/02; G06Q 20/18; G06Q 20/32; G06F 3/14

(52) U.S. Cl. CPC G06Q 20/387; G06F 3/14; G06Q 20/18; G06Q 20/389; G06Q 20/3276; G06Q 30/0223

(57) ABSTRACT

According to one embodiment, a commodity registration device for a self-service checkout system includes a display screen, a processor, and communication interface connectable to a registration support server. The processor is configured to receive an input of a commodity code identifying an item to be included in a customer transaction, then receive and store commodity detail data from the registration support server. The commodity detail data includes a commodity name and a price of the item corresponding to the commodity code. The processor causes the display screen to display commodity data for items included in the customer transaction in a list format. The commodity detail data of items in the list format associated with a price-cut condition are displayed in a distinguishable manner for those items in the list format that are not associated with any price-cut condition.

### CROSS-REFERENCE TO RELATED APPLICATION

The present application is based upon and claims the benefit of priorities from Japanese Patent Application No. 2021-169462, filed on Oct. 15, 2021, and Japanese Patent Application No. 2022-068399, filed on Apr. 18, 2022, the entire contents of which are hereby incorporated by reference.

### FIELD

Embodiments described herein relate generally to a commodity registration device and a commodity registration program.

### BACKGROUND

There is a sales promotion method in which a price-cut is provided if a certain number and/or type of items are purchased together in the same sales transaction. That is, if the registered items in the transaction satisfies some predetermined condition or conditions a discount is applied to either individual items in the transaction or to the transaction as a whole. A self-service type commodity registration device that a customer causes to read a code symbol attached to an item to be purchased may be configured to display in a popup format (e.g., as a “popup window”) sales promotion information related to certain items on or over a product registration related screen otherwise displayed. Sales promotion information may be so displayed if the conditions for a price-cut (discount) are satisfied because the customer used the device to read a particular product code or the like

However, generally, such a popup window is closed once a code of the next item is read. Accordingly, after the popup window is closed, it may be difficult for the customer to check the provided sales promotion information related to a previously registered product. Thus, there is a demand for improvement in such commodity registration devices.

### BRIEF DESCRIPTION OF THE DRAWINGS

FIG. 1 is a block diagram illustrating a schematic configuration of a commodity registration system according to an embodiment.

FIG. 2 is a schematic diagram of a commodity record.

FIG. 3 is a schematic diagram of a price-cut record.

FIG. 4 is a block diagram of a registration support server.

FIG. 5 is a schematic diagram of a transaction file.

FIG. 6 is a block diagram of an information terminal.

FIG. 7 is a schematic diagram of a list memory.

FIG. 8 is a schematic diagram of a total memory.

FIG. 9 is a schematic diagram of a tag table.

FIGS. 10 to 16 are flowcharts of processing executed by a processor of an information terminal.

FIG. 17 is a flowchart of detail analysis processing executed by a processor of an information terminal.

FIG. 18 is a flowchart of a registration screen editing processing executed by a processor of an information terminal.

FIG. 19 is a flowchart of check-in notification processing executed by a processor of a registration support server.

FIG. 20 is a flowchart of registration notification processing executed by a processor of a registration support server.

FIG. 21 is a flowchart of change notification processing executed by a processor of a registration support server.

FIG. 22 is a flowchart of payment notification processing executed by a processor of a registration support server.

FIG. 23 is a flowchart of settlement request command reception processing executed by a processor of a registration support server.

FIG. 24 is a schematic diagram illustrating an example of a check-in screen.

FIG. 25 is a schematic diagram illustrating an example of a registration screen.

FIG. 26 is a schematic diagram illustrating an example of a scan screen.

FIG. 27 is a schematic diagram illustrating an example of a registration screen.

FIG. 28 is a schematic diagram illustrating an example of a registration screen.

FIG. 29 is a schematic diagram illustrating an example of a registration screen.

FIG. 30 is a schematic diagram illustrating an example of a concluded price-cut confirmation screen.

FIG. 31 is a schematic diagram illustrating an example of an unconcluded price-cut confirmation screen.

FIG. 32 is a schematic diagram illustrating an example of a number-of-articles change screen.

FIG. 33 is a schematic diagram illustrating an example of a registration screen.

FIG. 34 is a schematic diagram illustrating an example of a checkout screen.

FIG. 35 is a schematic diagram illustrating a registration screen displayed on a touch panel of an information terminal in another embodiment.

FIG. 36 is a schematic diagram illustrating a registration screen displayed on a touch panel.

FIG. 37 is a schematic diagram illustrating another embodiment of a concluded price-cut confirmation screen displayed on a touch panel.

FIG. 38 is a schematic diagram illustrating an example of a checkout confirmation screen displayed on a display of a point-of-sale (POS) terminal or a dedicated checkout machine.

### DETAILED DESCRIPTION

An object of certain embodiments is to provide a commodity registration device on which information related to an applied price-cut related to a particular registered item can be easily checked by a user.

According to one embodiment, a commodity registration device for a self-service checkout system includes a display screen, a processor, and communication interface connectable to a registration support server. The processor is configured to receive an input of a commodity code identifying an item to be included in a customer transaction, then receive and store commodity detail data from the registration support server. The commodity detail data includes a commodity name and a price of the item corresponding to the commodity code. The processor is configured to cause the display screen to display commodity data for items included in the customer transaction in a list format. The commodity detail data of items in the list format associated with a price-cut condition are caused to be displayed in a distinguishable manner for those items in the list format that are not associated with any price-cut condition.

Certain example embodiments are explained below with reference to the drawings.

In an embodiment, a retail store where commodities are displayed has a selling floor (product display area) and a checkout floor in which checkout machines are set. The selling floor and checkout floor are separated from one another. The store permits a customer to operate a portable information terminal to input a code (e.g., scan a barcode) to register an item for purchasing by himself or herself. In such a store, a commodity registration system adapted to such a self-service style checkout process is constructed. Here, the information terminal is a form of a commodity registration device. As the information terminal, a smartphone carried by a customer, a dedicated portable terminal provided by the store, or a tablet terminal attached to a shopping cart can be used. In an example embodiment, the information terminal is a smartphone or the like carried by the customer.

Explanation of the configuration of a commodity registration system

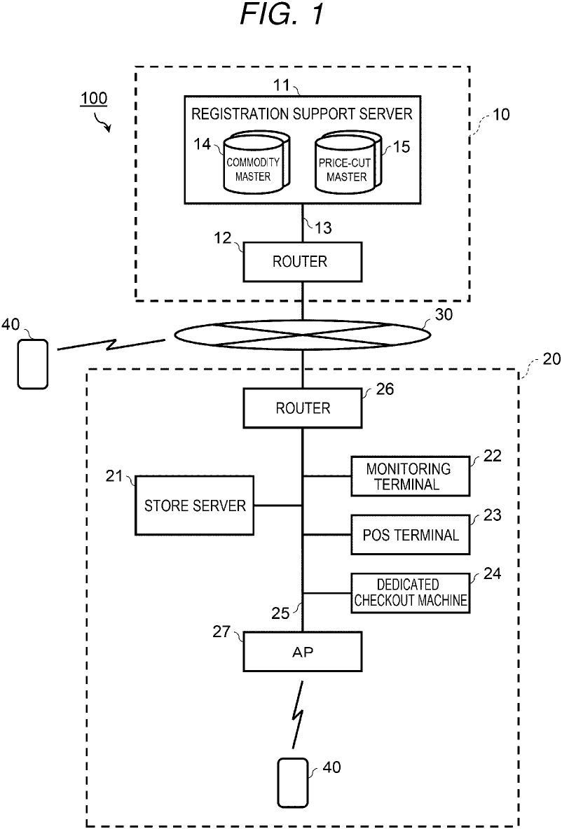

FIG. 1 is a block diagram illustrating a schematic configuration of a commodity registration system 100 according to this embodiment. The commodity registration system 100 includes a server system 10 that uses Cloud computing and a point-of-sale (POS) system 20 at a member store. The server system 10 and the POS system 20 enable bidirectional data communication through a network 30 that uses an Internet protocol. The network 30 is a wide-area network that uses a public line or a dedicated line as a relay network and uses a wired LAN (Local Area Network), a wireless LAN, a mobile communication network, a cellular phone communication network, or the like as an access network. An information terminal 40 that uses the cellular phone communication network, for example, a smartphone can access the server system 10 via the network 30.

The member store is a store having a use contract with a management company of the server system 10. In FIG. 1, the POS system 20 of one member store is illustrated. POS systems of other member stores are also connected to the network 30. However, the POS systems of the other member stores do not necessarily have the same configuration as the configuration of the POS system 20 illustrated in FIG. 1. A part of the configuration of the POS system could be different depending on the member store.

The server system 10 includes a registration support server 11 and a router 12. The registration support server 11 and the router 12 are connected by a communication line 13. The router 12 is connected to the network 30 as well and functions as a relay base for data communication performed using the network 30 between the registration support server 11 and the POS systems 20 of the member stores.

The registration support server 11 is a computer for supporting registration of products (commodities) for purchase by a customer who does shopping in a member store. For support, the registration support server 11 has at least the following two functions: a first function of performing registration processing of commodity sales data based on a code input into the information terminal 40, and a second function creating or transmitting the checkout data necessary for settlement of a customer sales transaction for the customer who uses the information terminal 40.

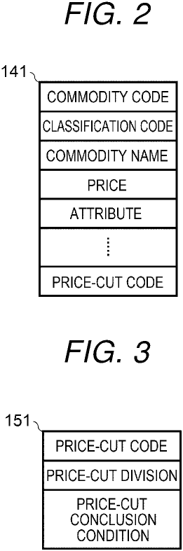

The registration support server 11 manages a commodity master 14 and a price-cut master 15 for each of the member stores in order to provide the first function. The commodity master 14 is an aggregate of commodity records 141 (see FIG. 2) created for each of commodities. The price-cut master 15 is an aggregate of price-cut records 151 (see FIG. 3) created for each of the price-cut conclusion conditions.

FIG. 2 is a schematic diagram illustrating a main data structure of a commodity record 141. As illustrated, the commodity record 141 is a data record storing commodity information such as a commodity code, a classification code, a commodity name, a price, an attribute, and a price-cut code. The commodity code is a unique code set for each commodity (product) in order to identify the commodities.

The classification code is a unique code set for each classification of commodities. The classifications may include food categories such as vegetables, fruits, meats, fish, beverages, dairy products, processed foods, or confectionery and/or categories concerning daily necessities such as kitchenware, bathing articles, laundry articles, and toilet articles. The classifications are not limited to these divisions and, in general, may be set arbitrarily. However, in this example, commodities specified by commodity codes belong to at least one of the classifications.

The commodity name and the price are a specific name and a normal price per one article of the commodity corresponding to the commodity code. In this context, an attribute is information concerning characteristics of the commodity, for example, whether the commodity is a price-cut target commodity or whether the commodity is a reduced tax rate target commodity. The price-cut code is a unique code set for each one of the price-cut conclusion conditions. The price-cut code is set for a price-cut target commodity. However, the price-cut code can be “0” or Null for a commodity excluded from price-cut targets.

FIG. 3 is a schematic diagram illustrating a main data structure of the price-cut record 151. As illustrated, the price-cut record 151 is a data record storing a price-cut code, a price-cut division, a price-cut conclusion condition.

The price-cut division is information indicating a type of a price-cut. In this embodiment, types of price-cuts are the following three types: “M&M price-cut”, “bundle sale price-cut”, and “single item price-cut”. The price-cut division of “M&M price-cut” is represented as “1”, the price-cut division of “bundle sale price-cut” is represented as “2”, and the price-cut division of “single item price-cut” is represented as “3”.

The “M&M price-cut” is a sales promotion method involving cutting a price if a predetermined number of commodities are purchased out of a plurality of items of commodities. Therefore, in the case of the “M&M price-cut”, price-cut conclusion conditions include a code for identifying a commodity listed as a target of the “M&M price-cut” type, the number of articles required for concluding a price-cut, and a sale amount after the price-cut conclusion. The code may be a particular commodity code or may be a particular classification code (such that any commodity within the classification code could meet the condition). For example, in the case of the “M&M price-cut” for “if two items are purchased out of confectionery priced at 220 yen, setting a sales amount of the two items in total to 400 yen”, the code is a commodity code set for candies priced at 220 yen or a classification code set for the confectionery priced at 220 yen. The number of articles for concluding a price-cut is “2”. The sales amount after price-cut conclusion is “400”.

The “bundle sale price-cut” is a sales promotion method involving cutting a price if a plurality of articles of the same type (commodity code) are purchased in a bundle. Therefore, in the case of the “bundle sale price-cut”, the price-cut conclusion conditions are a commodity code for identifying a commodity set as a target of the “bundle sale price-cut”, the number of articles for concluding a price-cut, and a sales amount after price-cut conclusion. For example, in the case of the “bundle sale price-cut” for “if two articles of a commodity A priced at 160 yen are purchased, setting a sales price of the two articles in total to 300 yen”, the code is a commodity code of the commodity A. The number of articles for concluding a price-cut is “2”. The sales amount after price-cut conclusion is “300”.

The “single item price-cut” is a sales promotion method involving cutting a price of a promotion target commodity if a total amount of the transaction in which the commodity is included is equal to or larger than some predetermined amount. Therefore, in the case of the “single item price-cut”, the price-cut conclusion conditions include a commodity code for identifying a commodity set as a target of the “single item price-cut”, a total amount (transaction total amount) for concluding a price-cut, and a price after price-cut conclusion. For example, in the case of the “single item price-cut” for “if a total amount a transaction is 1000 yen or more, selling a commodity priced at 120 yen at 100 yen”, the code is a commodity code of a commodity B. The total amount for concluding a price-cut is “1000”. The price after price-cut conclusion is “100”.

Referring back to FIG. 1, the POS system 20 includes a store server 21, a monitoring terminal 22, a POS terminal 23, and a dedicated checkout machine 24 and connects the store server 21, the monitoring terminal 22, and the dedicated checkout machine 24 via an in-store network 25. The POS system 20 connects a router 26 to the in-store network 25 and is connected to the network 30 via the router 26. Further, the POS system 20 connects an access point 27 to the in-store network 25 and enables data communication by a wireless LAN with the information terminal 40 via the access point 27.

The store server 21 is a computer for managing, based on information concerning a transaction settled by a member store in which the POS system 20 is constructed, sales information of the member store, stock information of commodities, ordering information, and the like.

The monitoring terminal 22 is a terminal for monitoring a customer who is performing code reading operation for purchasing commodities using the information terminal 40. The monitoring terminal 22 includes a monitor. Actions of the customer in the store, data relating to purchased (or registered) commodities of the customer, and the like can be displayed on the monitor.

The POS terminal 23 is a checkout machine that processes settlement of a transaction with a customer who does not use an information terminal 40. A store clerk can be an operator of the POS terminal 23. The POS terminal 23 may be a semi-self-service type POS terminal divided into a registration machine and a checkout machine, with the store clerk operating the registration machine and the customer operating the checkout machine. The POS terminal 23 may also or instead be a self-service type POS terminal operated by the customer alone.

The dedicated checkout machine 24 is a checkout machine that processes settlement of a transaction with a customer who uses the information terminal 40. A customer is an operator of the dedicated checkout machine 24. The dedicated checkout machine 24 includes a function of scanning a barcode for checkout displayed on the information terminal 40, a payment processing function corresponding to various payment methods such as electronic money, credit card, and cash, and a charging function for electronic money.

Explanation of the configuration of the registration support server

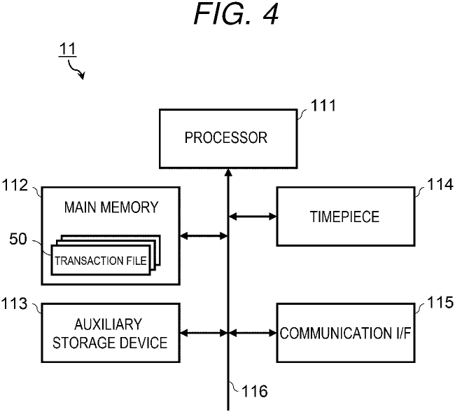

FIG. 4 is a block diagram of the registration support server 11. The registration support server 11 includes a processor 111, a main memory 112, an auxiliary storage device 113, a timepiece 114, a communication interface 115, and a system transmission line 116. The system transmission line 116 includes an address bus, a data bus, and a control signal line. The registration support server 11 connects the processor 111, the main memory 112, the auxiliary storage device 113, the timepiece 114, and the communication interface 115 to the system transmission line 116.

The processor 111 controls the units in order to realize various functions of the registration support server 11 according to an operating system or application programs (application software). The processor 111 is, for example, a CPU (Central Processing Unit).

The main memory 112 includes a nonvolatile memory region and a volatile memory region. The main memory 112 stores the operating system or the application programs in the nonvolatile memory region. The main memory 112 stores, in the volatile memory region, data necessary for the processor 111 in executing processing for controlling the units. The data is sometimes stored in the nonvolatile memory region. The main memory 112 uses the volatile memory region as a work area where data is rewritten as appropriate by the processor 111. The nonvolatile memory region is, for example, a ROM (Read Only Memory). The volatile memory region is, for example, a RAM (Random Access Memory).

For example, an EEPROM (Electric Erasable Programmable Read-Only Memory), a HDD (Hard Disc Drive), or an SSD (Solid-State Drive) can be the auxiliary storage device 113. The auxiliary storage device 113 saves data used by the processor 111 in performing various kinds of processing, data created by the processing in the processor 111, and the like. The auxiliary storage device 113 sometimes stores the application programs.

The timepiece 114 provides a date and time. The registration support server 11 acquires the data and the time clocked by the timepiece 114.

The communication interface 115 is a circuit for performing transmission and reception of data to and from respective kinds of equipment connected via the network 30 according to a predetermined communication protocol.

The registration support server 11 uses a part of the volatile region in the main memory 112 as a storage region for a plurality of transaction files 50. The transaction file 50 is created for each of customer who perform a code reading operation for purchase of commodities using the information terminal 40. Various data necessary for creation of checkout data are stored in the transaction file 50.

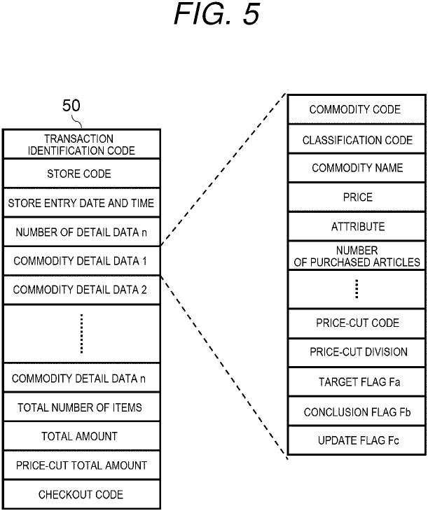

FIG. 5 is a schematic diagram illustrating main data stored in the transaction file 50. FIG. 5 illustrates, as one example, data of one record among a plurality of transaction records stored in the transaction file 50. The transaction file 50 stores data relating to a transaction of a customer who uses the information terminal 40. As illustrated in FIG. 5, a transaction identification code, a store code, a store entry date and time, the number of detail data n, commodity detail data as many as the number n, a total number of items, a total amount, a price-cut total amount, a checkout code, and the like are stored in the transaction file 50.

The transaction identification code is information for identifying a transaction of a customer. The transaction identification code is a code for identifying the information terminal 40 used by the customer. For example, an equipment ID of the information terminal 40 or a cellular phone number can be the transaction identification code. The transaction identification code may be, for example, a transaction number for identifying a transaction or may be, in addition to the transaction number, a code obtained by combining a store code and date and time information such as a store entry date and time. The transaction number is given, for example, when the server 11 generates a transaction file. The store code is a unique code set for each of the member stores in order to individually identify the member stores. The store entry date and time is a date and time when the customer starts an application for a commodity registration system operating in the information terminal 40 and checks in the member store.

The commodity detail data includes a commodity code, a classification code, a commodity name, a price, an attribute, the number of purchased articles, a price-cut code, and a price-cut division. The commodity code, the classification code, the commodity name, the price, the attribute, and the price-cut code are information of the commodity record 141. The price-cut division is information of the price-cut record 151.

The commodity detail data further includes a target flag Fa, a conclusion flag Fb, and an update flag Fc. The target flag Fa is one-bit data for identifying whether a registered commodity is a price-cut target commodity. The price-cut target commodity is a commodity for which a price-cut code other than “0” or NULL is set. In this embodiment, the target flag Fa of the price-cut target commodity is represented as “1” and a target flag of a commodity excluded from price-cut targets is represented as “0”. The conclusion flag Fb is one-bit data for identifying whether a price-cut of a price-cut conclusion condition specified by the price-cut code is concluded. In this embodiment, the conclusion flag Fb in the case in which the price-cut is concluded is represented as “1” and a conclusion flag in the case in which the price-cut is not concluded is represented as “0”. The update flag Fc is one-bit data for identifying whether the commodity detail data is updated data. In this embodiment, the update flag Fc of the updated commodity detail data is represented as “1” and the update flag Fc of the commodity detail data not updated is represented as “0”.

The total number of items is the number of items obtained by adding up the numbers of purchased articles of the respective commodity detail data. The total amount is an amount obtained by adding up purchase amounts of the respective commodity detail data. The purchase amount is calculated by multiplying the price by the number of purchased articles and subtracting a price-cut amount from the multiplied price. The price-cut total amount is an amount obtained by adding up price-cut amounts of purchase commodities. The checkout code is a code used in checkout of a transaction by a customer who checks in a member store specified by the store code at a store entry data and time using the information terminal 40.

Explanation of the configuration of the information terminal

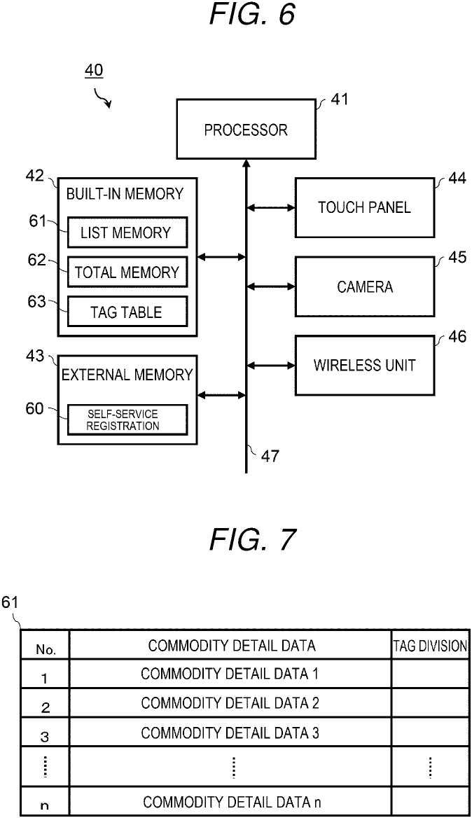

FIG. 6 is a block diagram of the information terminal 40. As illustrated in FIG. 6, the information terminal 40 includes a processor 41, a built-in memory 42, an external memory 43, a touch panel 44, a camera 45, a wireless unit 46, and a system transmission line 47.

The system transmission line 47 includes an address bus, a data bus, and a control signal line. The information terminal 40 connects the processor 41, the built-in memory 42, the external memory 43, the touch panel 44, the camera 45, and the wireless unit 46 to the system transmission line 47.

The processor 41 controls the units in order to realize various functions of the information terminal 40 according to an operating system or application programs (application software). The processor 41 is, for example, a CPU.

The built-in memory 42 includes a nonvolatile memory region and a volatile memory region. The built-in memory 42 stores the operating system or the application programs in the nonvolatile memory region. The built-in memory 42 stores, in the volatile memory region, data necessary for the processor 41 in executing processing for controlling the units. The built-in memory 42 uses the volatile memory region as a work area where data is rewritten as appropriate by the processor 41. The nonvolatile memory region is, for example, a ROM. The volatile memory region is, for example, a RAM.

For example, an SD memory card or a USB memory can be the external memory 43. The external memory 43 saves data used by the processor 41 in performing various kinds of processing, data created by processing in the processor 41, or the like. The external memory 43 sometimes stores the application programs.

The touch panel 44 is a device obtained by combining a display functioning as a display unit and a touch sensor functioning as a detecting unit. The display includes a screen for displaying various images. The touch sensor detects a position on a screen touched by the operator. The touch panel 44 acquires data input by the operator from the position on the screen detected by the touch sensor and information of an image displayed in the position.

The camera 45 is an imaging device incorporated in the information terminal 40. The processor 41 has a function of a reading unit for reading a code such as a barcode or a two-dimensional code from an image captured by the camera 45. Barcodes representing commodity codes of commodities in a predetermined barcode system are attached to the commodities. That is, the processor 41 can acquire a commodity code of a commodity by reading a barcode attached to the commodity from the image captured by the camera 45.

The wireless unit 46 is a communication device that performs data communication with the access point 27 according to a communication protocol of a wireless LAN. The wireless unit 46 configures a communication unit of the information terminal 40.

In the information terminal 40 having such a configuration, for example, a self-service registration program 60 is installed in the external memory 43. The self-service registration program 60 is application software for a commodity registration system executed by the information terminal 40. The self-service registration program 60 may be installed in the built-in memory 42. A method of installing the self-service program 60 in the built-in memory 42 or the external memory 43 is not particularly limited. The self-service registration program 60 can be installed in the built-in memory 42 or the external memory 43 by recording the self-service registration program 60 in a removable recording medium or distributing the self-service registration program 60 by communication via a network. The form of the recording medium does not matter so long as the recording medium can store programs and can be read by a device. For example, the recording medium may be an SD memory card, a USB memory, or the like.

In the information terminal 40 in which the self-service registration program 60 is installed, a part of a region of the built-in memory 42 is set as a region for a list memory 61, a total memory 62, and a tag table 63. The list memory 61, the total memory 62, and the tag table 63 may be formed in the external memory 43.

FIG. 7 is a schematic diagram illustrating the configuration of the list memory 61. As illustrated, the list memory 61 includes areas for storing commodity detail data and a tag division in association with a series of list numbers. The area of the commodity detail data stores commodity detail data stored in the transaction file 50 including a transaction identification code for identifying a transaction of a customer who uses the information terminal 40. The area of the tag division stores a tag division, which is identification information of a tag attached if a commodity name, a price, and the like of the commodity detail data are displayed on the touch panel 44 in a list format. Details of tags are explained below.

FIG. 8 is a schematic diagram illustrating the configuration of the total memory 62. As illustrated, the total memory 62 includes areas for storing a total number of items Ta, a total amount Tb, and a price-cut total amount Tc. The area of the total number of items Ta stores a total number of items stored in the transaction file 50 including a transaction identification code for identifying a transaction of a customer who uses the information terminal 40. The area of the total amount Tb stores a total amount stored in the transaction file 50. The area of the price-cut total amount Tc stores a price-cut total amount stored in the transaction file 50.

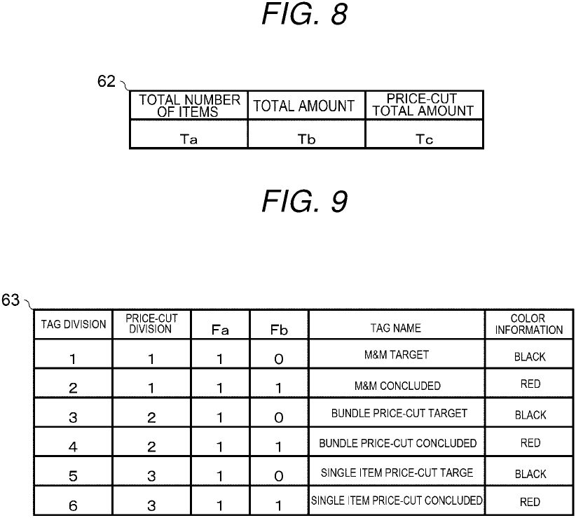

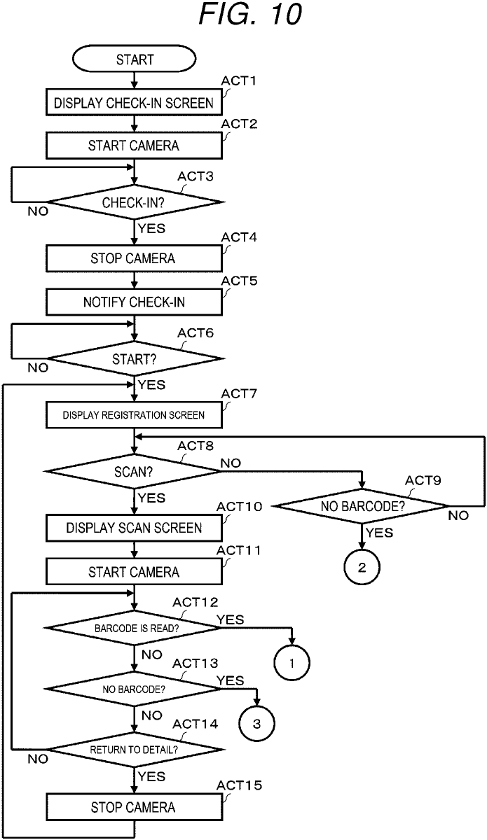

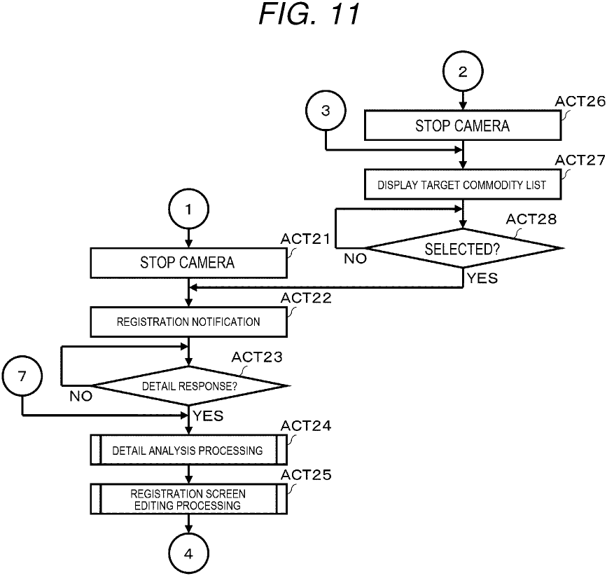

FIG. 9 is a schematic diagram illustrating the configuration of the tag table 63. As illustrated, the tag table 63 includes a column of a tag division, a column of a price-cut division, a column of the target flag Fa, a column of the conclusion flag Fb, a column of a tag name, and a column of color information.

In this embodiment, as the tag division “1”, a tag record in which the price-cut division is “1”, the target flag Fa is “1”, the conclusion flag Fb is “0”, the tag name is “M&M target”, and the color information is “black” is stored. That is, the tag division “1” is information for identifying a black character tag “M&M target” attached to information concerning a price-cut target commodity of the “M&M price-cut” for which a price-cut is not yet concluded.

In this embodiment, as the tag division “2”, a tag record in which the price-cut division is “1”, the target flag Fa is “1”, the conclusion flag Fb is “1”, the tag name is “M&M concluded”, and the color information is “red” is stored. That is, the tag division “2” is information for identifying a red character tag “M&M concluded” attached to information concerning a price-cut target commodity of the “M&M price-cut”, for which a price-cut is concluded.

In this embodiment, as the tag division “3”, a tag record in which the price-cut division is “2”, the target flag Fa is “1”, the conclusion flag Fb is “0”, the tag name is “bundle sale price-cut”, and the color information is “black” is stored. That is, the tag division “3” is information for identifying a black character tag “bundle price-cut target” attached to information concerning a price-cut target commodity of the “bundle sale price-cut” for which a price-cut is not yet concluded.

In this embodiment, as a tag division “4”, a tag record in which the price-cut division is “2”, the target flag Fa is “1”, the conclusion flag Fb is “1”, the tag name is “bundle price-cut concluded”, and the color information is “red” is stored. That is, the tag division “4” is information for identifying a red character tag “bundle price-cut concluded” attached to information concerning a price-cut target commodity of the “bundle sale price-cut” for which a price-cut is concluded.

In this embodiment, as a tag division “5”, a tag record in which the price-cut division is “3”, the target flag Fa is “1”, the conclusion flag Fb is “0”, the tag name is “single item price-cut target”, and the color information is “black” is stored. That is, the tag division “5” is information for identifying a black character tag “single item price-cut target” attached to information concerning a price-cut target commodity of the “single item price-cut” for which a price-cut is not yet concluded.

In this embodiment, as a tag division “6”, a tag record in which the price-cut division is “3”, the target flag Fa is “1”, the conclusion flag Fb is “1”, the tag name is “single item price-cut concluded”, and the color information is “red” is stored. That is, the tag division “6” is information for identifying a red character tag “single item price-cut concluded” attached to information concerning a price-cut target commodity of the “single item price-cut” for which a price-cut is concluded.

The tag names and the color information are not limited to those illustrated in FIG. 9. Appropriate tag names and color information can be set by a system administrator, a user, or the like.

Explanation of the operation of the commodity registration system

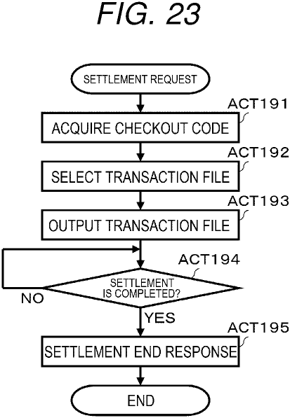

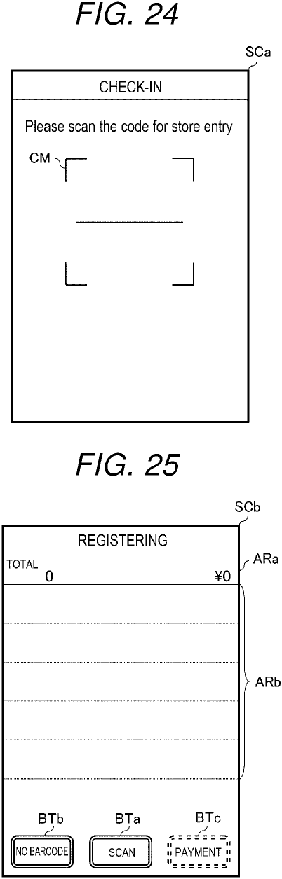

FIGS. 10 to 18 are flowcharts of information processing executed by the processor 41 of the information terminal 40 according to the self-service registration program 60. FIGS. 19 to 23 are flowcharts of information processing executed by the processor 111 of the registration support server 11 according to a program. FIGS. 24 to 34 are transition examples of screens displayed on the touch panel 44 of the information terminal 40. An operation of the commodity registration system 100 is explained below with reference to the drawings. The specific procedures and content of the operations explained below are non-limiting examples. The procedures and the content can be changed as appropriate so long the same effects can be achieved. The illustrate screens are non-limiting examples. Layouts, images, texts, and the like of the screens are not limited to those illustrated in the drawings.

A customer who does shopping using the information terminal 40 in a retail store at which the commodity registration system 100 is constructed starts the self-service registration program 60. Once the self-service registration program 60 is started, the processor 41 of the information terminal 40 starts the information processing of the procedure illustrated in FIG. 10. In ACT 1, the processor 41 causes the touch panel 44 to display a check-in screen SCa (see FIG. 24). In ACT 2, the processor 41 starts the camera 45.

A code for store entry is placed at an entrance of the store. The code for store entry can be encoded by a two-dimensional code system. The code may provide setting information such as a store code, in-store LAN data, and mobile communication data. The in-store LAN data is an SSID, a password, security information, and the like necessary for the information terminal 40 to be connected to the access point 27 using a wireless LAN. The mobile communication data is a timeout time, the number of times of retry, and the like necessary for the information terminal 40 to communicate with respective kinds of equipment of the commodity registration system 100.

FIG. 24 is an example of the check-in screen SCa. As illustrated, in the check-in screen SCa, a frame CM indicating a code reading region is arranged together with guidance for scanning of the code for store entry. The customer holds the camera 45 of the information terminal 40 over the code for store entry such that the code for store entry fits in the frame CM. Then, the code for store entry is read by the function of the reading unit of the information terminal 40.

In the above explanation, the camera 45 starts when the check-in screen SCa is displayed on the touch panel 44. However, timing when the camera 45 starts is not limited to this. For example, a camera start button may be displayed on the check-in screen SCa and the camera 45 may start when the camera start button is touched.

The processor 41 waits for check-in in ACT 3. After the code for store entry is scanned by the camera 45, the processor 41 recognizes that check-in has been performed and proceeds to ACT 4. In ACT 4, the processor 41 stops the camera 45.

In ACT 5, the processor 41 controls the wireless unit 46 to perform check-in notification. According to this control, the wireless unit 46 is connected to the access point 27 by the wireless LAN based on the in-store LAN data acquired from the code for store entry. After being connected to the access point 27, the wireless unit 46 wirelessly transmits a check-in notification command. The check-in notification command is received by the access point 27 and transmitted to the registration support server 11 via the router 26 of the POS system 20. The check-in notification command includes a terminal identification code set in the information terminal 40. The terminal identification code may be, for example, a code for uniquely identifying the information terminal 40 used by the customer. For example, an equipment ID of the information terminal 40 or a cellular phone number can be the terminal identification code. Alternatively, the terminal identification code may be a code for identifying the self-service registration program 60 stored in the information terminal 40 or a user who uses the program. For example, the terminal identification code may be a specific number automatically issued when the program is installed or a member number issued at the time of member registration by the customer. A store code acquired from the code for store entry is also included in the check-in notification command. Check-in notification processing is executed in the registration support server 11 that receives the check-in notification command.

FIG. 19 is a flowchart of the check-in notification processing. Upon receiving the check-in notification command via the communication interface 115, in ACT 131, the processor 111 of the registration support server 11 acquires a terminal identification code from the check-in notification command. In ACT 132, the processor 111 acquires a store ID from the check-in notification command. Further, in ACT 133, the processor 111 sets, as a store entry date and time, the present date and time as clocked by the timepiece 114. In ACT 134, the processor 111 creates the transaction file 50. In the transaction file 50, the transaction identification code, the store code acquired from the check-in notification command, and the store entry date and time are saved. The transaction identification code may be the terminal identification code acquired from the check-in notification command. The transaction identification code may be a transaction number. The transaction file 50 is stored in, for example, the main memory 112.

In ACT 135, the processor 111 transmits a start command to the information terminal 40 based on the terminal identification code or the like. If the transaction number is used as the transaction identification code, the processor 111 may transmit the start command including the transaction number (as the transaction identification code) to the information terminal 40. In this case, if the customer registers a commodity, the information terminal 40 can include the transaction identification code in a registration notification command. The registration support server 11 can manage information concerning the commodities registered by the customer in association with the transaction identification code.

The processor 111 creates the transaction file 50 in ACT 134. However, the timing for creating the transaction file 50 is not limited to this. The processor 111 may generate the transaction file 50 upon receiving a commodity code transmitted as a registration notification command by the information terminal 40 reading a barcode of a first commodity in a new transaction.

Referring back to FIG. 10, the processor 41 waits for a start command in ACT 6. Upon receiving the start command via the wireless unit 46, the processor 41 proceeds to ACT 7. In ACT 7, the processor 41 switches the screen of the touch panel 44 from the check-in screen SCa to a registration screen SCb (see FIG. 25).

FIG. 25 is an example of the registration screen SCb. As illustrated, on the registration screen SCb, a scan button BTa, a no barcode button BTb, and a payment button BTc are arranged. A part of the screen is set as a total display section ARa for a transaction and the remaining part of the screen is set as a detail list display section ARb for purchase commodities. The positions of the total display section ARa and the detail list display section ARb are fixed. In this embodiment, the detail list display section ARb is divided into five detail areas. Information such as commodity names, prices, and the numbers of purchased articles for up to a maximum of five items of purchase commodities can be displayed in this detail list display section ARb. If the number of purchase commodities is more than five, the commodity names and the like or previously registered items are stopped from being displayed in the detail list display section ARb so the more recently registered items can be displayed. However, for example, by swiping the detail list display section ARb, information concerning earlier registered items can be displayed in the detail list display section ARb. At the present point in time, since shopping is not yet started, the total number of items is 0, a total amount is 0 yen, and the detail areas of the detail list display section ARb are blank.

The scan button BTa is for instructing scanning of a barcode attached to a commodity. The no barcode button BTb is for instructing registration of a commodity to which no barcode is attached. The payment button BTc is for instructing payment of a price of a transaction. Since shopping is not started at the present point in time, the payment button BTc is grayed out and disabled. The registration screen SCb in which the payment button BTc is disabled may be referred to as registration start screen.

The customer checks the registration screen SCb and starts shopping. The customer walks around the selling floor and, upon finding a commodity to purchase, checks whether a barcode is attached to the commodity. If a barcode is attached to the commodity, the customer touches the scan button BTa. If a barcode is not attached to the commodity, the customer touches the no barcode button BTb.

In ACT 8, the processor 41 waits for the scan button BTa to be touched or, in ACT 9, waits for the no barcode button BTb to be touched.

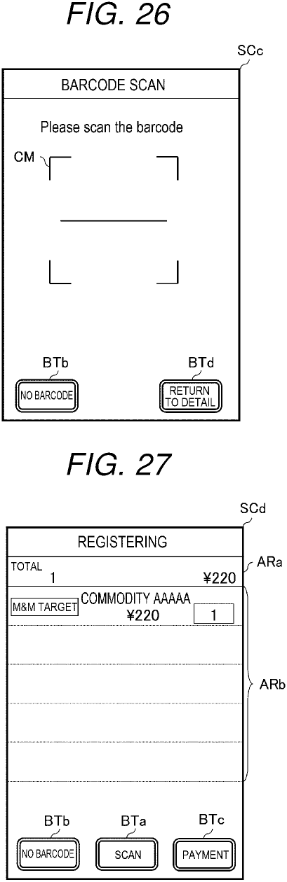

If the scan button BTa is touched in the waiting state in ACT 8 and ACT 9, the processor 41 proceeds to ACT 10. In ACT 10, the processor 41 switches the screen of the touch panel 44 from the registration screen SCb to a scan screen SCc (see FIG. 26). In ACT 11, the processor 41 starts the camera 45.

FIG. 26 is an example of the scan screen SCc. As illustrated, on the scan screen SCc, a frame CM indicating a code reading region is arranged together with guidance for guiding barcode scan for a commodity. On the scan screen SCc, the no barcode button BTb and a return-to-detail button BTd are arranged. The return-to-detail button BTd is for instructing to switch back the screen to the registration screen SCb. The code reading region is an image for supporting barcode reading.

The customer checks the scan screen SCc and holds the camera 45 of the information terminal 40 over the commodity such that the barcode fits on the inner side of the frame CM. Then, the barcode is read by the function of the reading unit of the information terminal 40. If a barcode is not attached to the commodity, the customer touches the no barcode button BTb. For switching back the screen to the registration screen SCb, the customer touches the return-to-detail button BTd.

In ACT 12, the processor 41 waits for a barcode to be read, in ACT 13, waits for the no barcode button BTb to be touched, or, in ACT 14, waits for the return-to-detail button BTd to be touched.

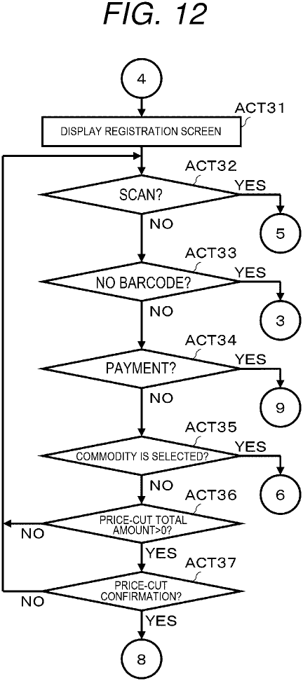

If a barcode is read in the waiting state in ACT 12 to ACT 14, the processor 41 proceeds to ACT 21 in FIG. 11. In ACT 21, the processor 41 stops the camera 45. In ACT 22, the processor 41 controls the wireless unit 46 to perform registration notification. According to the control, the wireless unit 46 wirelessly transmits a registration notification command. The registration notification command is received by the access point 27 and transmitted to the registration support server 11 via the router 26 of the POS system 20. The registration notification command includes data of the barcode read from the commodity to be purchased. The registration notification command includes a transaction identification code, which is information for identifying a transaction of the customer in the transaction file 50. For example, if the transaction identification code is a terminal identification code, the registration notification command includes a terminal identification code set in the information terminal 40. In the registration support server 11 that receives the registration notification command, registration notification processing is executed.

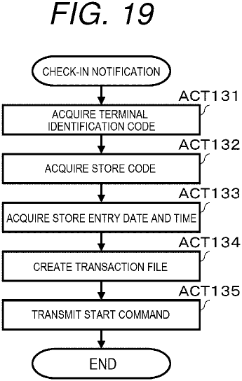

FIG. 20 is a flowchart illustrating a main part procedure of the registration notification processing. If receiving the registration notification command via the communication interface 115, in ACT 141, the processor 111 of the registration support server 11 acquires the transaction identification code from the registration notification command. In ACT 142, the processor 111 selects the transaction file 50 in which the transaction identification code is saved. In the following explanation, for convenience of explanation, a selected transaction file is referred to as transaction file 51.

In ACT 143, the processor 111 sets all of update flags Fc of commodity detail data stored in the transaction file 51 to “0”. Subsequently, in ACT 144, the processor 111 acquires a commodity code from the data of the barcode included in the registration notification command. In ACT 145, the processor 111 searches through the commodity master 14 with the commodity code. At this time, the processor 111 searches through the commodity master 14 of a member store identified by the store code saved in the transaction file 51.

In ACT 146, the processor 111 reads out, from the commodity master 14, commodity data such as a classification code, a commodity name, a price, an attribute, and a price-cut code stored in correlation with the commodity code. In ACT 147, the processor 111 creates commodity detail data of a registered commodity. As explained above, the commodity detail data includes a commodity code, a classification code, a commodity name, a price, an attribute, the number of purchased articles, a price-cut code, a price-cut division, the target flag Fa, the conclusion flag Fb, and the update flag Fc of the commodity. In the following explanation, the commodity detail data created in the processing in ACT 147 is referred to as created commodity detail data (or “first data”).

In ACT 148, the processor 111 checks the price-cut code of the created commodity detail data. If the price-cut code is “0” or Null, the price code is not set. The processor 111 proceeds to ACT 149. In ACT 149, the processor 111 sets the target flag FA of the created commodity detail data to “0” and sets the conclusion flag Fb of the created commodity detail data to “0”.

If a price-cut code other than “0” or Null is set in ACT 148, the processor 111 proceeds to ACT 150. In ACT 150, the processor 111 searches through the price-cut master 15 with the price-cut code and acquires a price-cut division and a price-cut conclusion condition associated with the price-cut code. At this time, the processor 111 searches through the price-cut master 15 of the member store identified by the store code saved in the transaction file 51.

In ACT 151, the processor 111 determines whether a price-cut of a type specified by the price-cut division is concluded. For example, if the price-cut division is “1” and the price-cut conclusion condition is a condition of “M&M price-cut” for “if two items are purchased out of confectionery priced at 220 yen, setting a sales amount of the two items in total to 400 yen”, the processor 111 searches for commodity detail data saved in the transaction file 51. If detecting commodity detail data in which the classification code is a classification code of confectionery, the price is 220 yen, and the conclusion flag Fb is “0”, that is, relevant commodity detail data (second data), the processor 111 determines that the price-cut is concluded. If failing in detecting relevant commodity detail data, the processor 111 determines that the price-cut is not concluded. If the number of items of the price-cut conclusion condition is, for example, “3”, the processor 111 determines that the price-cut is concluded if two relevant commodity detail data are detected from the transaction file 51.

If the price-cut is not concluded, the processor 111 proceeds to ACT 153. In ACT 153, the processor 111 sets the target flag Fa of the created commodity detail data to “1” and sets the conclusion flag Fb of the created commodity detail data to “0”.

If the price-cut is concluded, the processor 111 proceeds to ACT 154. In ACT 154, the processor 111 sets the target flag Fa of the created commodity detail data to “1” and sets the conclusion flag Fb of the created commodity detail data to “1”. The processor 111 changes the conclusion flag Fb of the relevant commodity detail data relating to the determination of the price-cut conclusion from “0” to “1”.

Incidentally, if the price-cut division is “2” and the price-cut conclusion condition is a condition of “bundle sale price-cut” for “if two articles of a commodity A priced at 160 yen are purchased, setting a sales amount of the two articles in total to 300 yen” in ACT 151, the processor 111 searches for commodity detail data saved in the transaction file 51. If detecting relevant commodity detail data in which the commodity code coincides with the commodity code of the created commodity detail data and the conclusion flag Fb is “0”, the processor 111 determines that the price-cut is concluded if a total number of items of the number of purchased articles of the relevant commodity detail data and the number of purchased articles of the created commodity detail data is a multiple of the number of bundle price-cut articles. If failing in detecting the relevant commodity detail data or the total number of items is not a multiple of the number of bundle price-cut articles, the processor 111 determines that the price-cut is not concluded. The number of bundle price-cut articles is “2” in the case of the price-cut conclusion condition explained above. For example, in a condition that a price-cut is concluded if three articles of the same commodity are purchased, the number of bundle price-cut articles is “3”.

If the price-cut is not concluded, the processor 111 proceeds to ACT 153. In ACT 153, the processor 111 sets the target flag Fa of the created commodity detail data to “1” and sets the conclusion flag Fb of the created commodity detail data to “0”. If the price-cut is concluded, the processor 111 proceeds to ACT 154. In ACT 154, the processor 111 sets the target flag Fa of the created commodity detail data to “1” and sets the conclusion flag Fb of the created commodity detail data to “1”. The processor 111 changes the conclusion flag Fb of the relevant commodity detail data relating to the determination of the price-cut conclusion from “0” to “1”.

If the price-cut division is “3” and the price-cut conclusion condition is a condition of “single item price-cut” for “if a total amount of a transaction is 1000 yen or more, selling a commodity B priced at 120 yen at 100 yen” in ACT 151, the processor 111 acquires the total amount saved in the transaction file 51. If an amount obtained by adding up the total amount and the price of the created commodity detail data is 1000 yen or more, the processor 111 determines that the price-cut is concluded. If the total amount is less than 1000 yen, the processor 111 determines that the price-cut is not concluded.

If the price-cut is not concluded, the processor 111 proceeds to ACT 153. In ACT 153, the processor 111 sets the target flag Fa of the created commodity detail data to “1” and sets the conclusion flag Fb of the created commodity detail data to “0”. If the price-cut is concluded, the processor 111 proceeds to ACT 154. In ACT 154, the processor 111 sets the target flag Fa of the created commodity detail data to “1” and sets the conclusion flag Fb of the created commodity detail data to “1”. If commodity detail data in which the created commodity detail data and the commodity code coincide is present among the commodity detail data saved in the transaction file 51, the processor 111 changes the conclusion flag Fb of the commodity detail data from “0” to “1”.

If finishing the processing in ACT 149, ACT 153, or ACT 154, the processor 111 proceeds to ACT 155. In ACT 155, the processor 111 saves the created commodity detail data in the transaction file 51. In ACT 156, the processor 111 updates the total number of items, the total amount, and the price-cut total amount of the transaction file 51. Specifically, the processor 111 adds the number of purchased articles of the created commodity detail data to the total number of items and adds the price of the created commodity detail data to the total amount. The processor 111 adds a price-cut amount to the price-cut total amount. The price-cut amount can be calculated. For example, in the case of the “M&M price-cut” in which the division flag is “1”, an amount obtained by subtracting the sales amount of the conclusion condition from an amount obtained by adding up the prices of the created commodity detail data in which the conclusion flag Fb is set to “1” in the processing in ACT 14 and the relevant commodity detail data is the price-cut amount. In the case of the “bundle price-cut” in which the division flag is “2”, an amount obtained by subtracting the sales amount of the conclusion condition from an amount obtained by multiplying the price of the created commodity detail data by the number of bundle price-cut articles of the conclusion condition is the price-cut amount. In the case of the “single item price-cut” in which the division flag is “3”, an amount obtained by subtracting the sales amount of the conclusion condition from an amount obtained by multiplying the price of the created commodity detail data by the number of bundle price-cut articles of the conclusion condition is the price-cut amount.

In ACT 157, the processor 111 sets the update flag Fc of the created commodity detail data saved in the transaction file 51 to “1”. The processor 111 sets the update flag Fc of the relevant commodity detail data in which the conclusion flag Fb is changed from “0” to “1” in ACT 154 to “1” as well.

Upon finishing the processing explained above, the processor 111 transmits a detail response command to the information terminal 40 in ACT 157. The detail response command includes the number of detail data n saved in the transaction file 51, all commodity detail data of the number of detail data n, a total number of items, a total amount, and a price-cut total amount.

Although not illustrated, if other commodity detail data in which the price-cut division is “3” and the conclusion flag Fb is “0” is present in the transaction file 50, after the processing in ACT 156, the processor 41 checks whether the updated total amount is now 1000 yen or more. If the total amount is 1000 yen or more, the processor 41 sets the conclusion flag Fb and the update flag Fc of the other commodity detail data to “1”. The processor 41 calculates a price-cut amount and adds the price-cut amount to the price-cut total amount.

Referring back to FIG. 11, in ACT 23, the processor 41 waits for a detail response command. If receiving the detail response command via the wireless unit 46, the processor 41 proceeds to ACT 24.

A registration of a commodity not attached to a barcode is explained. A commodity not attached to a barcode is often present in a store for certain types of commodities such as, particularly, perishables. If a barcode is not attached to a commodity to be registered for purchase, the customer touches the no barcode button BTb.

If the no barcode button BTb is touched in the waiting state in which the registration screen SCb is displayed on the touch panel 44, that is, the waiting state in ACT 8 and ACT 9 in FIG. 10, the processor 41 proceeds to ACT 27 in FIG. 11. If the no barcode button BTb is touched in the waiting state in which the scan screen SCc is displayed on the touch panel 44, that is, the waiting state in ACT 12 to ACT 14 in FIG. 10, the processor 41 proceeds to ACT 26 in FIG. 11 and, after stopping the camera 45, proceeds to ACT 27. In ACT 27, the processor 41 causes the touch panel 44 to display a list of commodities known to lack barcodes. In ACT 28, the processor 41 waits for a particular commodity to be selected or input.

The customer selects a commodity out of the list. After the commodity is selected, the processor 41 proceeds to ACT 22 explained above. That is, the processor 41 controls the wireless unit 46 to perform registration notification. According to the control, the wireless unit 46 wirelessly transmits a registration notification command. The registration notification command is received by the access point 27 and transmitted to the registration support server 11 via the router 26 of the POS system 20. The registration notification command includes a transaction identification code and a commodity code of the selected commodity.

In the registration support server 11 that received the registration notification command, the registration notification processing explained with reference to FIG. 20 is executed. Therefore, in ACT 23, the processor 41 waits for a detail response command. If receiving the detail response command via the wireless unit 46, the processor 41 proceeds to ACT 24.

In this way, for a commodity attached to a barcode, the information terminal 40 transmits the registration notification command including the barcode scanned by the camera 45 (that is, a commodity code used to specify the commodity) to the registration support server 11 and receives the detail response command from the registration support server 11. For a commodity not attached to a barcode, the information terminal 40 transmits the registration notification command including a commodity code used to specify the commodity selected out of the list of the commodities without barcodes displayed on the touch panel 44 to the registration support server 11 and receives the detail response command from the registration support server 11.

The camera 45 and the touch panel 44 function as an input unit that receives an input of commodity data used to register a commodity for purchase.

The processor 41 proceeds to ACT 24. In ACT 24, the processor 41 executes detail analysis processing.

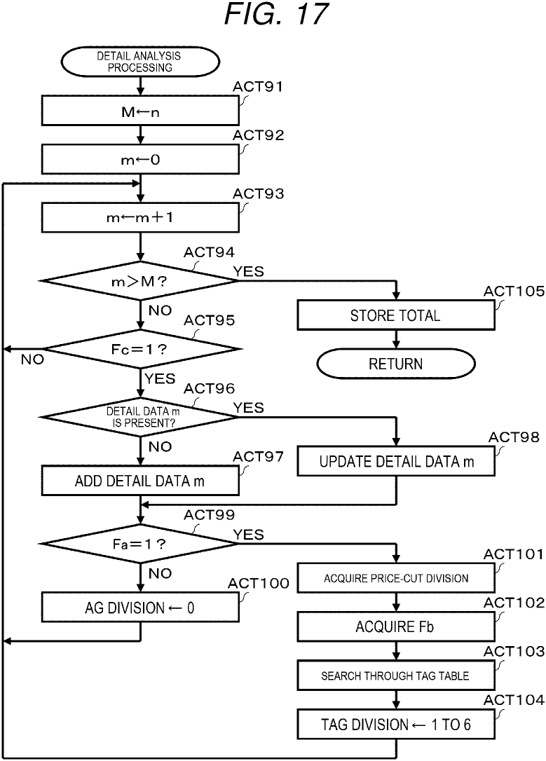

FIG. 17 is a flowchart illustrating a specific processing procedure of the detail analysis processing. If starting the detail analysis processing, in ACT 91, the processor 41 sets, in a register memory M, the number of detail data n included in the detail response command. In ACT 92, the processor 41 sets an initial value of a first counter m to “0”. Subsequently, in ACT 93, the processor 41 counts up the first counter m by “1”. In ACT 94, the processor 41 checks whether the first counter m exceeds a value of the register memory M.

If the first counter m does not exceed the value of the register memory M, the processor 41 proceeds to ACT 95. In ACT 95, the processor 41 checks whether the update flag Fc of m-th (m is a count value of the first counter m) commodity detail data included in the detail response command is “1”. If the update flag Fc is “0”, the processor 41 returns to ACT 93. That is, the processor 41 further counts up the first counter m by “1”. If confirming that the first counter m does not exceed the value of the registerer memory M, the processor 41 checks whether the update flag Fc of the m-th commodity detail data is “1”.

If the update flag Fc of the m-th commodity detail data is “1”, the processor 41 proceeds to ACT 96. In ACT 96, the processor 41 checks whether other commodity detail data in which a commodity code, a classification code, a commodity name, and a price coincide with those of the m-th commodity detail data is stored in the list memory 61. If relevant other commodity detail data is not stored in the list memory 61, the processor 41 proceeds to ACT 97. In ACT 97, the processor 41 adds the m-th commodity detail data to the list memory 61. In the following explanation, the commodity detail data added to the list memory 61 is referred to as added commodity detail data (third data).

The list memory 61 functions as a storing unit that stores commodity detail data including a commodity name and a price specified by commodity data.

In ACT 96, if relevant other commodity detail data is stored in the list memory 61, the processor 41 proceeds to ACT 98. In ACT 98, the processor 41 updates the number of purchased articles and the conclusion flag Fb of the relevant other commodity detail data to coincide with the m-th commodity detail data. In the following explanation, the commodity detail data updated on the list memory 61 is referred to as updated commodity detail data (fourth data).

If finishing the processing in ACT 97 or ACT 98, the processor 41 proceeds to ACT 99. In ACT 99, the processor 41 checks the target flag Fa of the added commodity detail data or the updated commodity detail data. If the target flag Fa is “0”, the processor 41 proceeds to ACT 100. In ACT 100, the processor 41 sets a tag division stored in the list memory 61 in correlation with the added commodity detail data or the updated commodity detail data to “0”.

If the target flag Fa of the added commodity detail data or the updated commodity detail data is “1”, the processor 41 proceeds to ACT 101. In ACT 101, the processor 41 acquires a price-cut division of the added commodity detail data or the updated commodity detail data. In ACT 102, the processor 41 acquires the conclusion flag Fb of the added commodity detail data or the updated commodity detail data.

In ACT 103, the processor 41 searches through the tag table 63 with the price-cut division and the conclusion flag Fb acquired from the added commodity detail data or the updated commodity detail data. In ACT 104, the processor 41 detects, from the tag table 63, tag divisions “1” to “6” in which the price-cut division and the conclusion flag Fb are associated and sets the tag divisions “1” to “6” as tag divisions stored in the list memory 61 in correlation with the added commodity detail data or the updated commodity detail data.

If finishing the processing in ACT 100 or ACT 104, the processor 41 returns to ACT 93. The processor 41 executes the processing in ACT 93 and subsequent acts in the same manner as explained above.

Thus, if the first counter m exceeds the value of the register M in ACT 94, the processor 41 proceeds to ACT 105. In ACT 105, the processor 41 stores the total number of items, the total amount, and the price-cut total amount included in the detail response command respectively in areas of the total number of items Ta, the total amount Tb, and the price-cut total amount Tc of the total memory 62. Then, the processor 41 ends the detail analysis processing.

Referring back to FIG. 11, if finishing the detail analysis processing, the processor 41 proceeds to ACT 25. In ACT 25, the processor 41 executes registration screen editing processing.

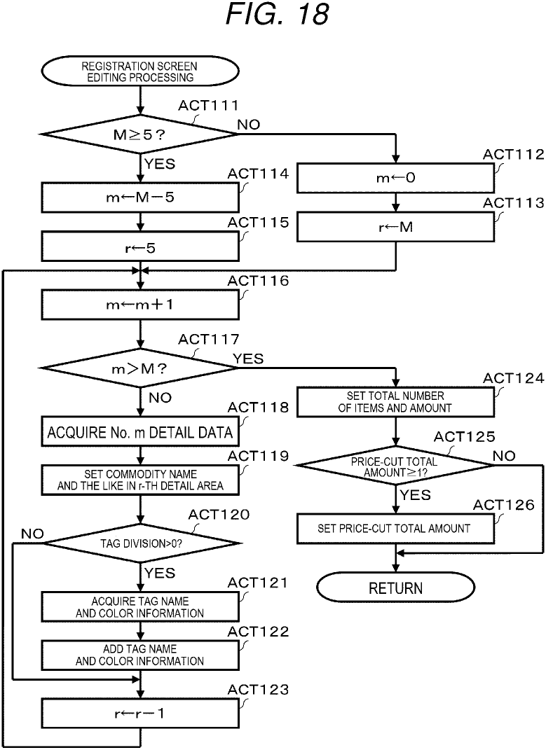

FIG. 18 is a flowchart illustrating a specific processing procedure of the registration screen editing processing. If starting the registration screen editing processing, in ACT 111, the processor 41 checks whether the value of the register memory M is “5” or larger. “5” is a maximum number of items that can be displayed on the detail list display section ARb of the registration screen. If the value of the register memory M is smaller than “5”, the processor 41 proceeds to ACT 112. In ACT 112, the processor 41 sets an initial value of the first counter m to “0”. In ACT 113, the processor 41 sets an initial value of a second counter r to the value of the register memory M.

If the value of the register memory M is “5” or larger in ACT 111, the processor 41 proceeds to ACT 114. In ACT 114, the processor 41 sets the initial value of the first counter m to a value obtained by subtracting “5” from the value of the register memory M. In ACT 115, the processor 41 sets the initial value of the second counter r to “5”.

If finishing the processing in ACT 113 or ACT 115, the processor 41 proceeds to ACT 116. In ACT 116, the processor 41 counts up the first counter m by “1”. In ACT 117, the processor 41 checks whether the first counter m exceeds the value of the register memory M.

If the first counter m does not exceed the value of the register memory M, the processor 41 proceeds to ACT 118. In ACT 118, the processor 41 acquires, from the list memory 61, commodity detail data in which a list number is “m”. In the following explanation, the commodity detail data acquired from the list memory 61 is referred to as acquired commodity detail data (fifth data).

In ACT 119, the processor 41 sets a commodity name, a price, and the number of purchased articles of the acquired commodity detail data in an editing buffer of the registration screen to be displayed in an r-th detail area from the bottom of the detail list display section ARb. The editing buffer is a part of the built-in memory 42. In ACT 119, the processor 41 may set the commodity name, the price, and the number of purchased articles in the editing buffer of the registration screen to be displayed in an r-th detail area from the top of the detail list display section ARb.

In ACT 120, the processor 41 checks a tag division stored in the list memory 61 in correlation with the acquired commodity detail data. If the tag division is other than “0”, the processor 41 proceeds to ACT 121. In ACT 121, the processor 41 searches through the tag table 63 and acquires a tag name and color information correlated with the tag division. In ACT 122, the processor 41 adds the tag name and the color information to information of the commodity name, the price, and the number of purchased articles set in the editing buffer in ACT 119. The processor 41 proceeds to ACT 123.

If the tag division is “0” in ACT 120, the processor 41 skips the processing in ACT 121 and ACT 122. The processor 41 proceeds to ACT 123. That is, if the tag division is “0”, the tag name and the color information are not added to the information of the commodity name, the price, and the number of purchased articles set in the editing buffer.

In ACT 123, the processor 41 counts down the second counter r by “1”. The processor 41 returns to ACT 116. The processor 41 executes the processing in ACT 116 and subsequent acts in the same manner as explained above. Therefore, the processor 41 repeats processing for sequentially acquiring m-th and subsequent commodity detail data from the list memory 61 and setting information of commodity names, prices, and the numbers of purchased articles of the acquired commodity detail data in the editing buffer. At that time, if a tag division other than “0” is stored in the list memory 61 in correlation with the acquired commodity detail data, the processor 41 adds a tag name and color information set in the tag table 63 in association with the tag division to the editing buffer.

If the first counter m exceeds the value of the register memory M in ACT 117, the processor 41 proceeds to ACT 124. In ACT 124, the processor 41 sets a total number of items and a total amount of the total memory 62 in the editing buffer to be displayed in the total display section ARa. In ACT 125, the processor 41 checks whether a price-cut total amount is 1 yen or more. If the price-cut total amount is 1 yen or more, in ACT 126, the processor 41 sets the price-cut total amount in the editing buffer to be displayed in the total display section ARa. If the price-cut total amount is 0 yen, the processor 41 skips the processing in ACT 126. Then, the processor 41 ends the registration screen editing processing.

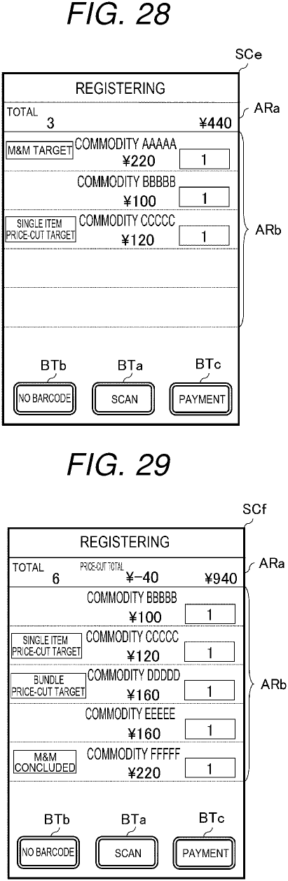

Referring back to FIG. 11, if finishing the registration screen editing processing, the processor 41 proceeds to ACT 31 in FIG. 12. In ACT 31, the processor 41 switches the screen of the touch panel 44 from the scan screen SCc or the screen of the target list of the commodities without barcodes to a registration screen SCd (see FIG. 27), a registration screen SCe (see FIG. 28), or a registration screen SCf (see FIG. 29).

FIG. 27 is an example of the registration screen SCd at the time when commodity detail data of a “commodity AAAAA” (a first item) is stored in the list memory 61 as registered item. The “commodity AAAAA” is a promotion target commodity, a price-cut conclusion condition for which is the “M&M price-cut” for “if two items are purchased out of confectionery priced at 220 yen, setting a sales amount of the two items in total to 400 yen”. Thus, at the present point in time, the “M&M price-cut” is not yet concluded (satisfied). Therefore, as illustrated in FIG. 27, a tag name “M&M target” is displayed in black characters in the top detail area of the detail list display section ARb together with a commodity name, a price, and the number of purchased articles of the “commodity AAAAA”. In the total display section ARa, a total number of items “one” and a total amount “220 yen (¥220)” are displayed.

The touch panel 44 displays the registration screen commodity detail data in a list format for the registered items in the transaction.

In ACT 32, the processor 41 waits for the scan button BTa to be touched, in ACT 33, waits for the no barcode button BTb to be touched, in ACT 34, waits for the payment button BTc to be touched, or, in ACT 35, waits for any one of purchase commodities displayed in the detail list display section ARb to be selected. In ACT 36, the processor 41 checks whether a price-cut total amount is larger than 0 yen. Since the price-cut total amount is 0 yen at this point in time, the processor 41 returns to ACT 32. That is, the processor 41 comes into the waiting state in ACT 32 to ACT 35.

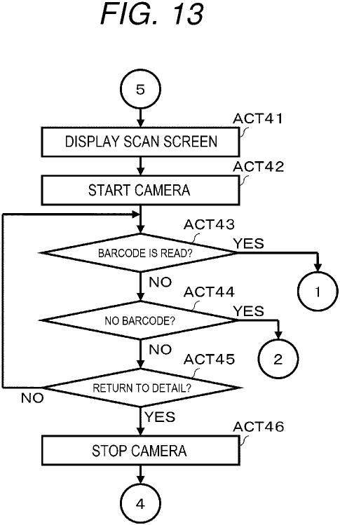

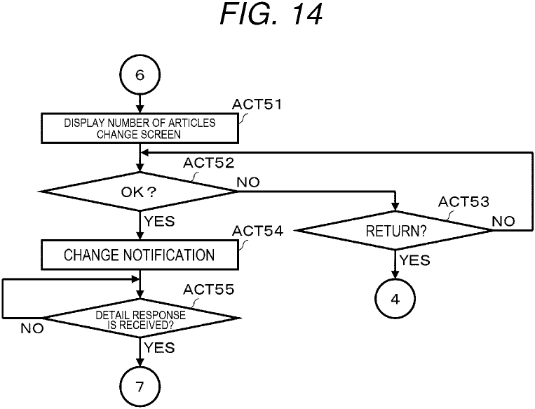

If the scan button BTa is touched in the waiting state in ACT 32 to ACT 35, the processor 41 proceeds to ACT 41 in FIG. 13. In ACT 41, the processor 41 switches the screen of the touch panel 44 from the registration screen SCd to the scan screen SCc (see FIG. 26). In ACT 42, the processor 41 starts the camera 45. Thereafter, in ACT 43, the processor 41 waits for a barcode to be read, in ACT 44, waits for the no barcode button BTb is touched, or, in ACT 45, waits for the return-to-detail button BTd is touched.

If a barcode is read in the waiting state in ACT 43 to ACT 45, the processor 41 proceeds to ACT 21 in FIG. 11. The processor 41 executes the processing in ACT 21 and subsequent acts in the same manner as explained above. If the no barcode button BTb is touched, the processor 41 proceeds to ACT 26 in FIG. 11. The processor 41 executes the processing in ACT 26 and subsequent acts in the same manner as explained above. That is, the processor 41 transmits the registration notification command including the commodity code of the commodity to the registration support server 11. Upon receiving the detail response command from the registration support server 11, the processor 41 executes the detail analysis processing and the registration screen editing processing and switches the screen of the touch panel 44 to the registration screen SCe (see FIG. 28) or the registration screen SCf (see FIG. 29).

If the return-to-detail button BTd is touched in the waiting state in ACT 43 to ACT 45, the processor 41 proceeds to ACT 46. In ACT 46, the processor 41 stops the camera 45. The processor 41 returns to ACT 31 in FIG. 12. The processor 41 switches back the screen of the touch panel 44 from the scan screen SCc to the immediately preceding registration screen SCd.

FIG. 28 is an example of the registration screen SCe at the time when commodity detail data of “commodity BBBBB” (a second item) and commodity detail data of “commodity CCCCC” (a third item) are stored in the memory list 61 as registered products. The “commodity BBBBB” is a commodity excluded from price-cut targets. The “commodity CCCCC” is a promotion target commodity, a price-cut conclusion condition for which is “single item price-cut” for “if a total amount of a transaction is 1000 yen or more, selling the commodity CCCCC priced at 120 yen at 100 yen”. Both of the “M&M price-cut” and the “single item price-cut” conditions are not yet concluded at the present point in time. Therefore, as illustrated in FIG. 28, the tag name “M&M target” displayed in the top detail area of the detail list display section ARb does not change. A commodity name, a price, and the number of purchased articles of the “commodity BBBBB” are displayed in a second detail area from the top of the detail list display section ARb. A tag name “single item price-cut target” is displayed in black characters in a third detail area together with a commodity name, a price, and the number of purchased articles of the “commodity CCCCC”. A total number of items “three” and a total amount “440 yen (¥440)” are displayed in the total display section ARa.

FIG. 29 is an example of the registration screen SCf at the time when commodity detail data of a “commodity DDDDD” (fourth item), commodity detail data of a “commodity EEEEE” (fifth item), and commodity detail data of a “commodity FFFFF” (sixth item) are respectively stored in the list memory 61 as registered commodities. The “commodity DDDDD” is a promotion target commodity, a price-cut conclusion condition for which is “bundle sale price-cut” for “if two articles of the commodity DDDDD priced at 160 yen are purchased, setting a sales amount of the two articles in total to 300 yen”. The “commodity EEEEE” is a commodity excluded from the price-cut targets. Like the “commodity AAAAA”, the “commodity FFFFF” is a promotion target commodity, a price-cut conclusion condition for which is “M&M price-cut” for “if two items are purchased out of confectionery priced at 220 yen, setting a sales amount of the two items in total to 400 yen”. Therefore, the “single item price-cut” and the “bulk sale price-cut” are not yet concluded but the “M&M price-cut” condition is concluded.

As a result, as illustrated in FIG. 29, the commodity name, the price, and the number of purchased articles of the “commodity BBBBB” are displayed in the top detail area of the detail list display section ARb. The tag name “single item price-cut target” is displayed in black characters in the second detail area together with the commodity name, the price, and the number of purchased articles of the “commodity CCCCC”. A tag name “bundle price-cut target” is displayed in black characters in the third detail area together with a commodity name, a price, and the number of purchased articles of the “commodity DDDDD”. A commodity name, a price, and the number of purchased articles of the “commodity EEEEE” are displayed in a fourth detail area. Further, a tag name “M&M concluded” is displayed in red characters in a fifth detail area together with a commodity name, a price, and the number of purchased articles of the “commodity FFFFF”. The tag name “M&M concluded” may also be displayed in red characters for information concerning the “commodity AAAAA” for which the M&M price-cut is concluded in combination with the “commodity FFFFF”. A price-cut total amount “-40 yen (¥-40)” is displayed in the total display section ARa together with a total amount of items “6” and a total amount “940 yen (¥940)”. A total amount displayed in the total display section ARa is an amount obtained by subtracting a price-cut total amount from a total amount of registered commodities.

Therefore, the tag name “M&M concluded” attached to the “commodity FFFFF” is displayed in red characters, whereby the customer confirms that the “M&M price-cut” is concluded. However, since the number of detail data n set in the register memory M exceeds the maximum number of items “5” that can be displayed in the detail list display section ARb, information concerning the “commodity AAAAA” (which is a sixth purchase commodity registered before the most recently registered “commodity FFFFF”) is not displayed in the detail list display section ARb. Therefore, the customer cannot check, on the register screen SCf, information concerning another “commodity AAAAA” for which the “M&M price-cut” is concluded according to the combination with the “commodity FFFFF”. By swiping the detail list display section ARb of the registration screen SCf with a finger, the customer can confirm that the tag name “M&M concluded” is displayed in the information related to “commodity AAAAA”. However, information concerning the “commodity FFFFF” is removed from the detail list display section ARb. Therefore, the customer performs a price-cut confirmation operation. For example, the customer touches the price-cut total amount displayed in the total display section ARa of the registration screen SCf. Alternatively, if a price-cut confirmation button is displayed on the registration screen SCf, the customer touches the price-cut confirmation button. At that time, the number of articles for which the price-cut is concluded is desirably displayed in batch on the price-cut confirmation button.

As illustrated in FIG. 12, if confirming in ACT 36 that the price-cut total amount is larger than 0 yen, the processor 41 proceeds to ACT 37. In ACT 37, the processor 41 checks whether the price-cut confirmation operation is performed. If the price-cut confirmation operation is performed, the processor 41 proceeds to ACT 61 in FIG. 15.

In ACT 61, the processor 41 checks whether commodity detail data in which the tag division “1” is set is present in the list memory 61. If commodity detail data in which the tag division “1” is set, that is, commodity detail data for which [M&M price-cut] is not concluded is stored in the list memory 61, in ACT 62, the processor 41 detects commodity detail data in which the tag division “1” is set. The processor 41 writes the detected commodity detail data in an M&M unconcluded commodity buffer. If commodity detail data in which the tag division “1” is set is absent, the processor 41 skips the processing in ACT 62.

Subsequently, in ACT 63, the processor 41 checks whether commodity detail data in which the tag division “2” is set is present in the list memory 61. If commodity detail data in which the tag division “2” is set, that is, commodity detail data for which [M&M price-cut] is concluded is stored in the list memory 61, in ACT 64, the processor 41 detects commodity detail data in which the tag division “2” is set. The processor 41 writes the detected commodity detail data in an M&M concluded commodity buffer. If commodity detail data in which the tag division “2” is set is absent, the processor 41 skips the processing in ACT 64.

Subsequently, in ACT 65, the processor 41 checks whether commodity detail data in which the tag division “3” is set is present in the list memory 61. If commodity detail data in which the tag division “3” is set, that is, commodity detail data for which [bundle sale price-cut] is not concluded is stored in the list memory 61, in ACT 66, the processor 41 detects the commodity detail data in which the tag division “3” is set. The processor 41 writes the detected commodity detail data in a bundle price-cut unconcluded commodity buffer. If commodity detail data in which the tag division “3” is set is absent, the processor 41 skips the processing in ACT 66.

Subsequently, in ACT 67, the processor 41 checks whether commodity detail data in which the tag division “4” is set is present in the list memory 61. If commodity detail data in which the tag division “4” is set, that is, commodity detail data for which the [bundle sale price-cut] is concluded is stored in the list memory 61, in ACT 68, the processor 41 detects the commodity detail data in which the tag division “4” is set. The processor 41 writes the detected commodity detail data in a bundle price-cut concluded commodity buffer. If commodity detail data in which the tag division “4” is set is absent, the processor 41 skips the processing in ACT 68.

Subsequently, in ACT 69, the processor 41 checks whether commodity detail data in which the tag division “5” is set is present in the list memory 61. If commodity detail data in which the tag division “5” is set, that is, commodity detail data for which [single item price-cut] is not concluded is stored in the list memory 61, in ACT 70, the processor 41 detects the commodity detail data in which the tag division “5” is set. The processor 41 writes the detected commodity detail data in a single item price-cut unconcluded commodity buffer. If commodity detail data in which the tag division “5” is set is absent, the processor 41 skips the processing in ACT 70.

Subsequently, in ACT 71, the processor 41 checks whether commodity detail data in which the tag division “6” is set is present in the list memory 61. If commodity detail data in which the tag division “6” is set, that is, commodity detail data for which the [single item price-cut] is concluded is stored in the list memory 61, in ACT 72, the processor 41 detects the commodity detail data in which the tag division “6” is set. The processor 41 writes the detected commodity detail data in a single item price-cut concluded commodity buffer. If commodity detail data in which the tag division “6” is set is absent, the processor 41 skips the processing in ACT 72.

All of the M&M unconcluded commodity buffer, the M&M concluded commodity buffer, the bundle price-cut unconcluded commodity buffer, the bundle price-cut concluded commodity buffer, the single item price-cut unconcluded commodity buffer, and the single item price-cut concluded commodity buffer are parts of a built-in memory.

Then, if finishing the processing in ACT 61 to ACT 72, the processor 41 proceeds to ACT 73. In ACT 73, the processor 41 causes the touch panel 44 to display a concluded price-cut confirmation screen SCg (see FIG. 30). The concluded price-cut confirmation screen SCg is a screen created based on the commodity detail data stored in the M&M concluded commodity buffer, the bundle price-cut concluded commodity buffer, or the single item price-cut concluded commodity buffer.

FIG. 30 is an example of the concluded price-cut confirmation screen SCg displayed if the price-cut confirmation operation is performed on the registration screen SCf illustrated in FIG. 29. As illustrated, on the concluded price-cut configuration screen SCg, information indicating that the M&M price-cut is concluded by a combination of the commodity AAAAA and the commodity FFFFF and a price-cut amount of the M&M price-cut is 40 yen (¥-40) is displayed in a region ARc. The same total display section ARa as the total display section ARa of the registration screen SCf and an OK button BTe are arranged on the concluded price-cut confirmation screen SCg. A hyperlink of a message MSa “other campaigns of attention” is displayed in a part of the region ARc. Content of the message MSa is an example. The message MSa is not displayed if commodity detail data is not stored in all of the M&M unconcluded commodity buffer, the bundle price-cut unconcluded commodity buffer, and the single item price-cut unconcluded commodity buffer.

The customer, who confirms the concluded price-cut confirmation screen SCg, can learn, from information in the region ARc, information and a price-cut amount of a commodity for which the M&M price-cut is concluded. If finishing the confirmation, the customer touches the OK button BTe. Alternatively, the customer touches the message MSa.

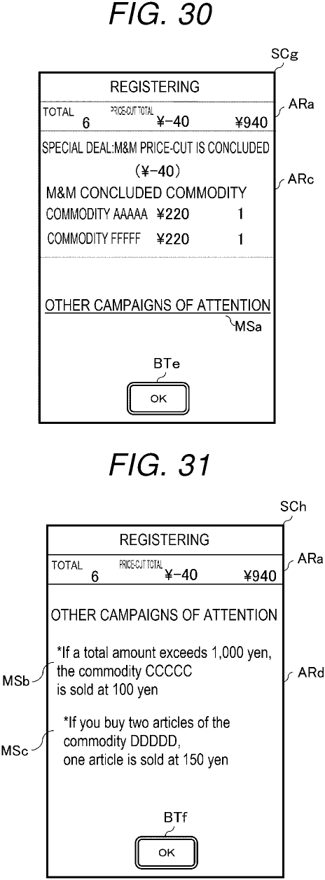

In ACT 74, the processor 41 waits for the OK button BTe to be touched or, in ACT 75, waits for the message MSa to be touched. If the message MSa is touched, the processor 41 proceeds to ACT 76. In ACT 76, the processor 41 causes the touch panel 44 to display an unconcluded price-cut confirmation screen SCh (see FIG. 31). The unconcluded price-cut confirmation screen SCh is a screen created based on the commodity detail data stored in the M&M unconcluded commodity buffer, the bundle price-cut unconcluded commodity buffer, or the single item price-cut unconcluded commodity buffer.

FIG. 31 is an example of the unconcluded price-cut confirmation screen SCh displayed if the message MSa is touched on the concluded price-cut confirmation screen SCg illustrated in FIG. 30. As illustrated, on the unconcluded price-cut confirmation screen SCh, a message MSb created based on the commodity detail data written in the bundle price-cut unconcluded commodity buffer and a message MSc created based on the commodity detail data written in the single item price-cut unconcluded commodity buffer are displayed in a region ARd. The same total display section ARa as the total display section ARa of the concluded price-cut confirmation screen SCg and an OK button BTf are arranged on the unconcluded price-cut confirmation screen SCh.

That is, in the single item price-cut unconcluded commodity buffer, commodity detail data of a target commodity, a price-cut conclusion condition for which is “unit price price-cut” for “if a total amount of a transaction is 1000 yen or more, selling the commodity CCCCC priced at 120 yen at 100 yen” is written. Therefore, the message MSb “if a total amountexceeds 1000 yen, the commodity CCCCC is sold at 100 yen” is displayed in the region ARd.

Similarly, in the bundle price-cut unconcluded commodity buffer, commodity detail data of a target commodity, a price-cut conclusion condition for which is “bundle sale price-cut” for “if two articles of the commodity DDDDD priced at 160 yen are purchased, setting a sales amount of the two articles in total to 300 yen” is written. Therefore, the message MSc “if two articles of the commodities DDDDD are purchased, one article is sold at 150 yen” is displayed in the region ARd. Contents of the message MSb and the message MSc are examples.

Therefore, with the message MSb and the message MSc in the region ARd, the customer can learn that the commodity CCCCC is sold at 100 yen if the total amount exceeds 1000 yen and that one more article of the commodity DDDDD is purchased, one article is sold at 150 yen. On the concluded price-cut confirmation screen SCg and the unconcluded price-cut confirmation screen SCh, the total display section ARa is arranged as on the registration screen SCf. Therefore, the customer can always check a total number of items, a price-cut total amount, and a total amount after a price-cut.

The customer confirms the unconcluded price-cut confirmation screen SCh and touches the OK button BTf.

In ACT 77, the processor 41 waits for the OK button BTf to be touched. If the OK button BTf is touched, the processor 41 returns to ACT 73. That is, the processor 41 switches back the screen of the touch panel 44 to the concluded price-cut confirmation screen SCg. Further, if the OK button BTe is touched, the processor 41 returns to ACT 31 in FIG. 12. That is, the processor 41 switches back the screen of the touch panel 44 to the immediately preceding registration screen SCf.

If determining to purchase one more article of the commodity DDDDD, the customer checks the message MSc and operates the information terminal 40 to input a commodity code of the commodity DDDDD. Alternatively, the customer changes the number of purchased articles of the commodity DDDDD displayed in the registration screen SCf from “1” to “2”. Such a change of the number of purchased articles is possible by performing selection operation for the commodity DDDDD displayed on the registration screen SCf. The selection operation is tap operation, flic operation, or swipe operation for an area where a commodity name and the like are displayed. The selection operation may be other operation.

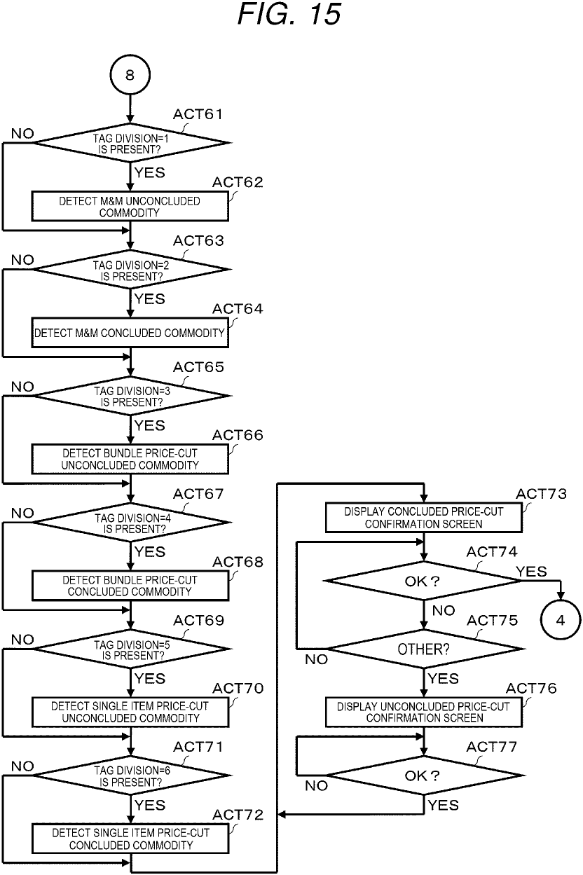

That is, if the selection operation for a commodity is performed in the waiting state in ACT 32 to ACT 35, the processor 41 proceeds to ACT 51 in FIG. 14. In ACT 51, the processor 41 switches the screen of the touch panel 44 from the registration screen SCf to a number of articles change screen SCi (see FIG. 32) .

FIG. 32 is an example of the number of articles change screen SCi displayed if the commodity DDDDD is selected in FIG. 29. As illustrated, on the number of articles change screen SCi, the number of purchased articles “1” before a change is displayed in a number of articles area ARe. An addition button BTg is arranged on one side and a subtraction button BTh is arranged on the other side across the number of articles area ARe. Further, a return without change button BTi and an OK button BTj are arranged.

The customer checks the number of articles change screen SCi and touches the addition button BTg or the subtraction button BTh and changes the number of articles displayed in the number of articles area ARe. For example, if changing the number of purchased articles of the commodity DDDDD to two, the customer touches the addition button BTg once and changes the number of articles in the number of articles area ARe to “2”. Incidentally, if cancelling the purchase of the commodity DDDDD, the customer only has to touch the subtraction button BTh once and change the number of articles in the number of articles area ARe to “0”. If finishing changing the number of articles, the customer touches the OK button BTj. If stopping the change of the number of articles, the customer touches the return without change button BTi.

Referring back to FIG. 14, in ACT 52, the processor 41 waits for the OK button BTj to be touched or, in ACT 53, waits for the return without change button BTi to be touched. If the return without change button BTi is touched in the waiting state in ACT 52 and ACT 53, the processor 41 returns to ACT 31 in FIG. 12. That is, the processor 41 switches back the screen of the touch panel 44 to the immediately preceding registration screen SCf.

If the OK button BTj is touched in the waiting state in ACT 52 and ACT 53, in ACT 54, the processor 41 controls the wireless unit 46 to perform change notification. According to the control, the wireless unit 46 wirelessly transmits a change notification command. The change notification command is received by the access point 27 and transmitted to the registration support server 11 via the router 26 of the POS system 20. The change notification command includes the number of articles in the number of articles area ARe, that is, the number of purchased articles after the change together with a commodity code of a change target commodity. The change notification command also includes a transaction identification code stored in the information terminal 40.

In the registration support server 11 that receives the change notification command, change notification processing is executed.

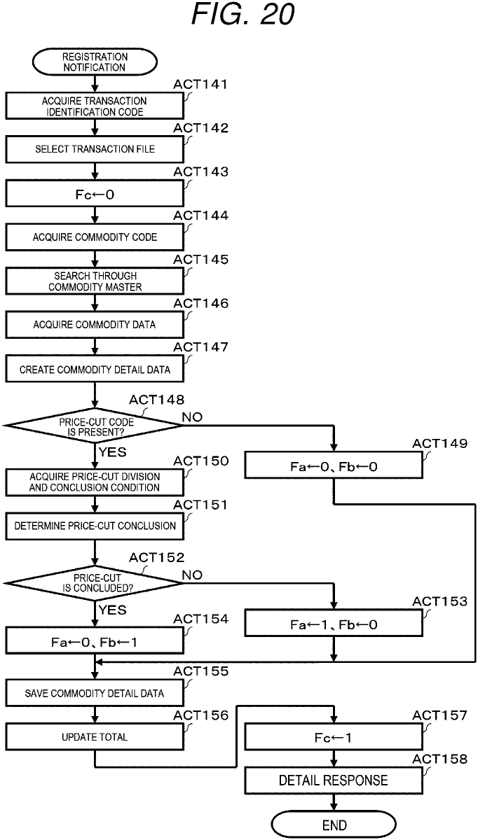

FIG. 21 is a flowchart of the change notification processing. If receiving the change notification command via the communication interface 115, in ACT 161, the processor 111 of the registration support server 11 acquires the transaction identification code from the change notification command. In ACT 162, the processor 111 selects the transaction file 51 in which the transaction identification code is saved.

In ACT 163, the processor 111 sets all of the update flags Fc of the commodity detail data stored in the transaction file 51 to “0”. Subsequently, in ACT 164, the processor 111 selects commodity detail data of the commodity code included in the change notification command out of the commodity detail data stored in the transaction file 51 and changes the number of purchased articles of the commodity detail data to the number of purchased articles included in the change notification command. In the following explanation, the commodity detail data in which the number of purchased articles is changed is referred to as changed commodity detail data (sixth data).

In ACT 165, the processor 111 checks a price-cut code of the changed commodity detail data. If the price-cut code is “0” or Null, the price-cut code is not set. The processor 111 proceeds to ACT 171.

If a price-cut code other than “0” or Null is set in ACT 165, the processor 111 executes the same processing as the processing explained as ACT 150 to ACT 154 in the registration notification processing above in ACT 166 to ACT 170. That is, the processor 41 searches through the price-cut master 15 with the price-cut code and acquires a price-cut division and a price-cut conclusion condition associated with the price-cut code. The processor 111 determines whether a price-cut of a type specified by the price-cut division is concluded. If the price-cut is not concluded, the processor 111 sets the target flag Fa of the changed commodity detail data to “1” and sets the conclusion flag Fb of the changed commodity detail data to “0”. If the price-cut is concluded, the processor 111 sets the target flag Fa of the changed commodity detail data to “1” and sets the conclusion flag Fb of the changed commodity detail data to “1”. The processor 111 changes the conclusion flag Fb of relevant commodity detail data relating to the determination of the price-cut conclusion from “0” to “1”.

Upon finishing the processing in ACT 169 or ACT 170, the processor 111 proceeds to ACT 171. In ACT 171, the processor 111 recalculates a total number of items, a total amount, and a price-cut total amount of the transaction file 51. In ACT 172, the processor 41 sets the update flag Fc of the changed commodity detail data to “1”. In ACT 170, the processor 111 also sets the update flag Fc of the relevant commodity detail data, the conclusion flag Fb of which is changed from “0” to “1” to “1”.

Upon finishing the processing explained above, the processor 111 transmits a detail response command to the information terminal 40 in ACT 173.

Referring back to FIG. 14, in ACT 55, the processor 41 waits for the detail response command. If receiving the detail response command via the wireless unit 46, the processor 41 proceeds to ACT 24 in FIG. 11. In ACT 24, the processor 41 executes detail analysis processing. Subsequently, in ACT 25, the processor 41 executes registration screen editing processing. In ACT 31, the processor 41 displays a registration screen SCj and returns to the waiting state in ACT 32 to ACT 35 or the waiting state including ACT 37.

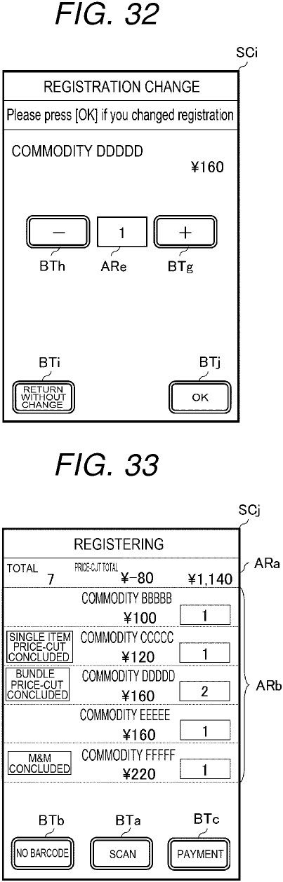

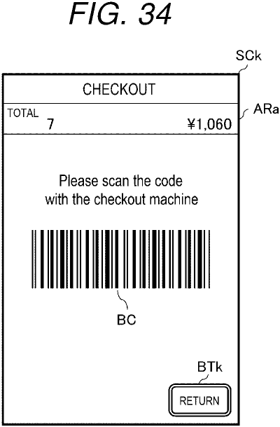

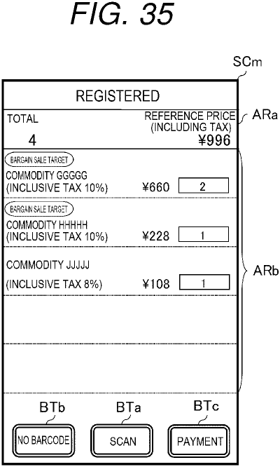

FIG. 33 is an example of the registration screen SCf displayed if the number of purchased articles of the commodity DDDDD is changed from “1” to “2” on the registration screen SCf illustrated in FIG. 29. Since the number of purchased articles of the commodity DDDDD is set to “2”, a price-cut conclusion condition of the [bundle sale price-cut] for the commodity DDDDD is satisfied. As a result, a tag displayed in a detail area of the commodity DDDDD changes to a tag name “bundle price-cut concluded” and is displayed in red characters. Therefore, the customer can learn that the [bundle sale price-cut] of a price-cut amount of 20 yen for the commodity DDDDD is concluded.

At this time, since the total amount exceeds 1000 yen, a price-cut conclusion condition of the [single item price-cut] for the commodity CCCCC is also satisfied. As a result, a tag displayed in a detail area of the commodity CCCCC changes to a tag name “single item price-cut concluded” and is displayed in red characters. Therefore, the customer can also learn that the [single item price-cut] of a price-cut amount of 20 yen for the commodity CCCCC is concluded.

If a price-cut confirmation operation is performed for a price-cut total amount “-80 yen (¥-80)” of the registration screen SCf, the screen of the touch panel 44 changes to a concluded price-cut confirmation screen. On the concluded price-cut confirmation screen, information concerning the commodity AAAAA and the commodity FFFFF relating to M&M price-cut conclusion, information concerning the commodity DDDDD relating to bundle sale price-cut conclusion, and information concerning the commodity CCCCC relating to single item price-cut conclusion are respectively divided and displayed. At this point in time, commodity detail data is not stored in the M&M unconcluded commodity buffer, the bundle price-cut unconcluded commodity buffer, and the single item price-cut unconcluded commodity buffer. Therefore, the hyperlink of the message MSa “other campaigns of attention” is not displayed.

The processor 41 that executes the detail analysis processing and the registration screen editing processing functions as a control unit that, if a price-cut of a transaction target commodity, commodity detail data of which is stored by the storing unit, is concluded according to commodity data input via the input unit, causes the display unit to display commodity detail data of transaction target commodities for which a price-cut is concluded displayed on the display unit in a list format to be distinguishable from the commodity detail data of other transaction target commodities. The processor 41 also functions as a control unit that causes the display unit to display a price-cut amount generated because the price-cut of the transaction target commodity is concluded. Further, the processor 41 also functions as a control unit that causes the display unit to display commodity detail data of transaction target commodities for which a price-cut is likely to be concluded among the transaction target commodities, the commodity detail data of which are displayed on the display unit in the list format, to be distinguishable from the commodity detail data of other transaction target commodities.

Further, the processor 41 also functions as a control unit that controls display of a concluded price-cut confirmation screen to, if receiving a price-cut confirmation instruction after a price-cut of a transaction target commodity is concluded, extract commodity detail data of the transaction target commodity for which the price-cut is concluded and cause the display unit to display the commodity detail data. Further, the processor 41 also functions as a control unit that controls display of an unconcluded price-cut confirmation screen to cause the display unit to display information insufficient for a price-cut of a transaction target commodity, for which the price-cut is likely to be concluded, to be concluded.

The customer who finishes shopping touches the payment button BTc of the registration screen SCj.

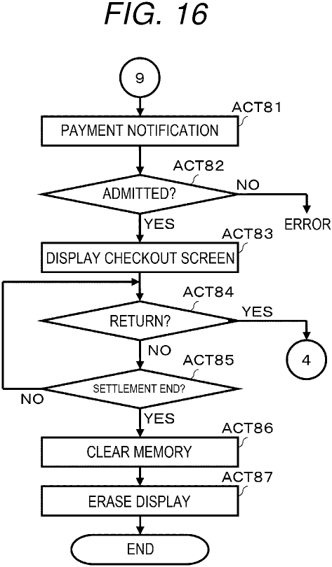

The processor 41 that is in the waiting state in ACT 32 to ACT 35 in FIG. 12 proceeds to ACT 81 in FIG. 16 if the payment button BTc is touched. In ACT 81, the processor 41 controls the wireless unit 46 to perform payment notification. According to the control, the wireless unit 46 wirelessly transmits a payment notification command. The payment notification command is received by the access point 27 and transmitted to the registration support server 11 via the router 26 of the POS system 20. The payment notification command includes a transaction identification code.

In the registration support server 11 that receives the payment notification command, payment notification processing is executed.

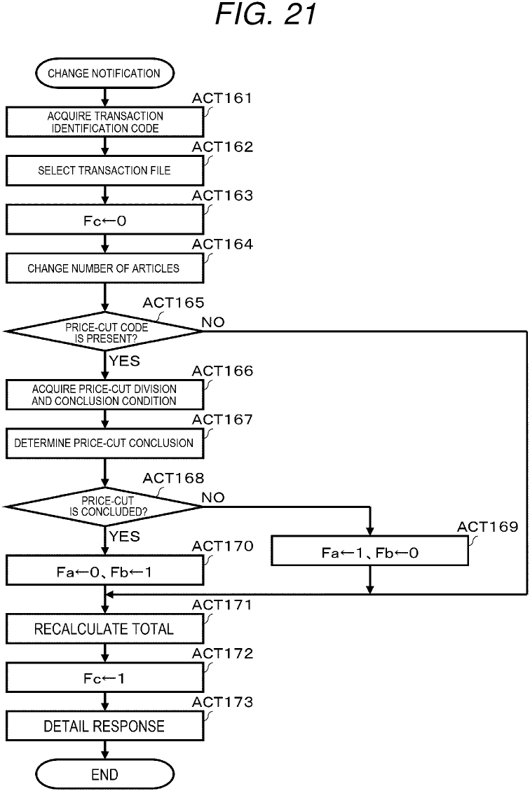

FIG. 22 is a flowchart of the payment notification processing. If receiving the payment notification command via the communication interface 115, in ACT 181, the processor 111 of the registration support server 11 acquires the transaction identification code from the payment notification command. In ACT 182, the processor 111 selects the transaction file 51 in which the transaction identification code is saved.

In ACT 183, the processor 111 analyzes data saved in the transaction file 51 and checks whether settlement can be performed. For example, about a commodity, a commodity name, a price, and the like of which are not successfully read out with respect to a commodity code, detail data in an error state remains. In this case, settlement cannot be performed.

If settlement cannot be performed, the processor 111 proceeds to ACT 184. In ACT 184, the processor 111 notifies a store terminal used by an attendant for monitoring that a customer who purchases an error commodity declares settlement. In ACT 185, the processor 111 transmits a negative response command to the information terminal 40. The attendant who receives the notification takes measures such as confirmation of a purchased commodity of the customer.

If settlement can be performed, the processor 111 proceeds to ACT 186. In ACT 186, the processor 111 creates a unique checkout code. In ACT 187, the processor 111 saves the checkout code in the transaction file 51. In ACT 188, the processor 111 transmits a permissive response command to the information terminal 40.

Referring back to FIG. 16, in ACT 82, the processor 41 waits for a response command. If receiving the negative response command from the registration support server 11, the processor 41 performs error processing. For example, the processor 41 causes the touch panel 44 to display an error message such as “You cannot settle payment by yourself. Please settle payment with a manned checkout machine”.

If receiving the permissive response command, the processor 41 proceeds to ACT 83. In ACT 83, the processor 41 switches the screen of the touch panel 44 from the registration screen to a checkout screen SCk (see FIG. 34).

FIG. 34 is an example of the checkout screen SCk displayed if the payment button BTc is touched on the registration screen SCj illustrated in FIG. 33. As illustrated, a checkout code is displayed as a barcode BC on the checkout screen SCk. A return button BTk is arranged on the checkout screen SCk.

In ACT 84, the processor 41 waits for the return button BTk to be touched or, in ACT 85, waits for a settlement end response command to be received. If the return button BTk is touched, the processor 41 returns to ACT 31 in FIG. 12. The processor 41 switches back the screen of the touch panel 44 from the checkout screen SCk to the immediately preceding registration screen SCj. The processor 41 comes into the waiting state in ACT 32 to ACT 35 in FIG. 12.

The settlement end response command is sent from the registration support server 11 if the customer finishes the checkout in the dedicated checkout machine 24. The customer checks the checkout screen SCk and scans the barcode BC on the checkout screen SCk with a scanner of the dedicated checkout machine 24. Then, a settlement request command is transmitted from the dedicated checkout machine 24 to the registration support server 11. The settlement request command includes data of the barcode BC, that is, a checkout code.

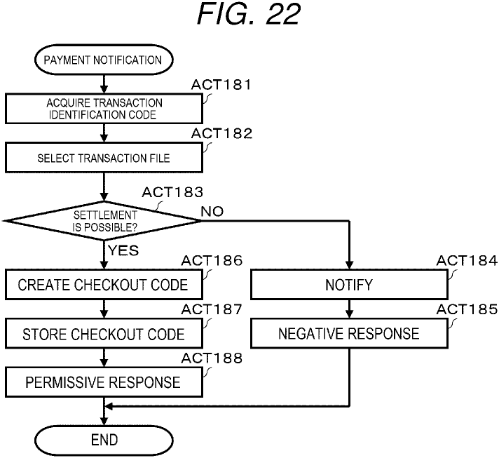

The processor 111 of the registration support server 11 receives the settlement request command and starts settlement request processing of a procedure illustrated in FIG. 23. That is, in ACT 191, the processor 111 acquires the checkout code from the settlement request command. In ACT 192, the processor 111 selects the transaction file 51 in which the transaction identification code is saved.

In ACT 193, the processor 111 transmits data of the transaction file 51 to the dedicated checkout machine 24. Consequently, content of the transaction is displayed on a display of the dedicated checkout machine 24. Therefore, the customer pays a price after checking the content. If the payment of the price is completed, a settlement completion command is transmitted from the dedicated checkout machine 24 to the registration support server 11.

In ACT 194, the processor 111 waits for the settlement completion command. If receiving the settlement completion command, the processor 111 proceeds to ACT 195. In ACT 195, the processor 111 transmits the settlement end response command to the information terminal 40 specified by the transaction identification code of the transaction file 51.

Referring back to FIG. 16, the processor 41 of the information terminal 40 displays the checkout screen SCk and, if receiving the settlement end response command, proceeds to ACT 86. In ACT 86, the processor 41 clears the list memory 61 and the total memory 62. In ACT 87, the processor 41 erases the checkout screen SCk. Then, the self-service shopping performed using the information terminal 40 ends.

### Effects of the Information Terminal

As explained above, in the detail list display section ARb of the registration screen displayed on the touch panel 44 of the information terminal 40, the commodity name, the price, and the like of the purchased commodity, the commodity data of which is input by the customer operating the information terminal 40, are displayed in the list format. If the price-cut such as the [M&M price-cut], the [bundle sale price-cut], or the [single item price-cut] is concluded, the tag is displayed together with the commodity name and the like of the commodity, the price of which is cut. For example, the tag having the tag name “M&M concluded” is displayed for the registered commodity for which the price-cut conclusion condition of the [M&M price-cut] is satisfied. The tag having the tag name “bundle price-cut concluded” is displayed for the registered commodity for which the price-cut conclusion condition of the [bundle sale price-cut] is satisfied. The tag having the tag name “single item price-cut concluded” is displayed for the registered commodity for which the price-cut conclusion condition of the [single item price-cut] is satisfied. Therefore, from the information of the tag displayed in the detail list display section ARb, the customer can easily specify the registered commodity for which the price-cut is concluded.

Moreover, if the price-cut is concluded, the price-cut total amount is displayed in the total display section ARa of the registration screen together with the total number of items and the total amount. Therefore, the customer can also easily learn a total of a price-cut amount generated by the conclusion of the price-cut.

If the price-cut confirmation operation is performed on the registration screen of the information terminal 40, the screen of the touch panel 44 changes to the concluded price-cut confirmation screen. The number of items of purchase commodities that can be displayed in the detail list display section ARb is limited. For example, in the case of the registration screen SCf illustrated in FIG. 29, maximum five items are displayed in the detail list display section ARb in descending order of registration. That is, information concerning commodities registered sixth or earlier is erased from the detail list display section ARb. Accordingly, for example, information concerning the commodity AAAAA for which the M&M price-cut is concluded together with the commodity FFFFF is not displayed in the detail list display section ARb. Even in such a case, the customer performs the price-cut confirmation operation, whereby the screen of the touch panel 44 transitions to the concluded price-cut confirmation screen SCg illustrated in FIG. 30. Therefore, the customer can collectively check, with simple operation, information concerning commodities relating to a concluded price-cut.

For a commodity that is a price-cut target commodity of the [M&M price-cut], the [bundle sale price-cut], the [single item price-cut], or the like for which a price-cut is not concluded, a tag having the tag name “M&M target”, the tag name “bundle price-cut target”, or the tag name “single item price-cut target” is displayed in the detail list display section ARb together the a commodity name and the like. Therefore, the customer can easily identify, from information of the tag displayed in the detail list display section ARb, a registered commodity for which a price-cut could be concluded by additional commodity registrations or the like. Moreover, the tag attached to a registered commodity for which a price-cut is not yet concluded is colored differently from a tag attached to a registered commodity for which a price-cut has been concluded. Therefore, the customer can easily distinguish, from the color of the tags, whether a commodity is associated with a price-cut that is not concluded or a price-cut that is concluded.

If the message MSa “other campaigns of attention” displayed on the concluded price-cut confirmation screen SCg of the information terminal 40 is selected, the screen of the touch panel 44 transitions to the unconcluded price-cut confirmation screen SCh illustrated in FIG. 31. Therefore, the customer can easily learn information indicating what is still insufficient with respect to receiving a possible price-cut on a registered commodity.

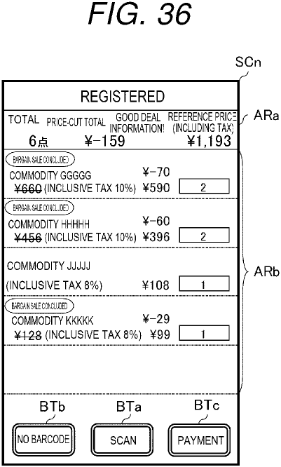

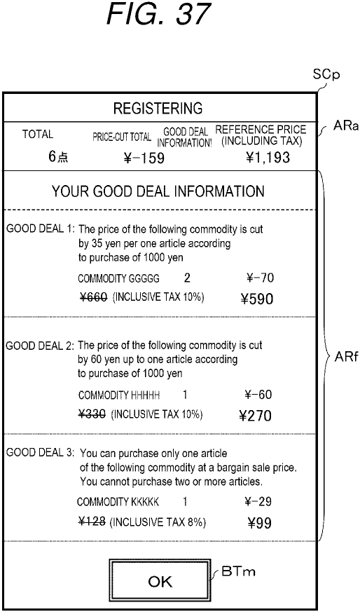

Other embodiments FIGS. 35 and 36 are schematic diagrams illustrating registration screens displayed on the touch panel 44 of the information terminal 40 in another embodiment. FIG. 35 illustrates a registration screen SCm before price-cut conclusion in which four articles in total including two of a commodity GGGGG, one of a commodity HHHHH, and one of a commodity JJJJJ are registered. FIG. 36 illustrates a registration screen SCn after a price-cut is concluded by additionally registering another one of the commodity HHHHH and one of a commodity KKKKK. In this embodiment, types of the price-cut are “amount designated price-cut”, “amount and number-of-articles limited price-cut”, and “number-of-articles limited price-cut”.

The “amount designated price-cut” is a sales promotion method involving collectively cutting a price of a price-cut target commodity if a total amount of the transaction is equal to or greater than some set amount. Therefore, in the case of the “amount designated price-cut”, price-cut conclusion conditions include a code for identifying a target commodity of the “amount designated price-cut”, a set amount, and a price-cut amount. The code may be a commodity code or may be a classification code.

In registration screen examples illustrated in FIGS. 35 and 36, the commodity GGGGG is a target commodity of the “amount designated price-cut”. Specifically, the “amount designated price-cut” for “selling the commodity GGGGG having a unit price of 330 yen at a price-cut of 35 yen if a total amount of a transaction is 1000 yen or more”. On the registration screen SCm illustrated in FIG. 35, since a total amount of a transaction is 996 yen and is less than 1000 yen, the “amount designated price-cut” is not concluded. Accordingly, on the detail list display section ARb, a commodity name “commodity GGGGG” and tax type information “inclusive tax 10%”, the number of purchased articles “2” and a sales price “660 yen” for the number of purchased articles, and a tag with a tag name “bargain sale target” are displayed. The tag name may be set as “amount designed price-cut target”. However, since the number of characters increases, the tag name is set as “bargain sale target”. On the registration screen SCn illustrated in FIG. 36, since a total amount of a transaction is 1193 yen and is 1000 yen or more, the “amount designated price-cut” is concluded. Since the number of purchased articles is “2”, a price of each of the two articles is cut by 35 yen. Accordingly, on the detail list display section ARb, a commodity name “commodity GGGGG” and tax type information “inclusive tax 10%”, the number of purchased articles “2” and a sale price before price-cut “660 yen”, a price-cut amount “-70 yen” and a sales price after price-cut “590 yen”, and a tag with a tag name “bargain sale concluded” are displayed. A deletion line is drawn on the sales price before price-cut “660 yen”. The tag name may be set as “amount designated price-cut concluded”. However, since the number of characters increases, the tag name is set as “bargain sale concluded”. The tag name may be simply “bargain sale”.

The “amount and number-of-articles limited price-cut” is a sales promotion method involving cutting a price of a target commodity by a predetermined price-cut amount for up to a set number of articles. Therefore, in the case of the “amount and number-of-articles limited price-cut”, price-cut conclusion conditions include a code for identifying a target commodity of the “amount and number-of-articles limited price-cut”, a set amount, a set number of articles, and a price-cut amount. The code may be a commodity code or may be a classification code.

In the registration screen examples illustrated in FIGS. 35 and 36, the commodity HHHHH is a target commodity of the “amount and number-of-articles limited price-cut”. Specifically, the “amount and number-of-articles limited price-cut” for “selling only one article of the commodity HHHHH having a unit price of 228 yen at a price-cut of 60 yen if a total amount of a transaction is 1000 yen or more”. On the registration screen SCm illustrated in FIG. 35, since a total amount of a transaction is 996 yen and is less than 1000 yen, the “amount and number-of-articles limited price-cut” is not concluded. Accordingly, on the detail list display section ARb, a commodity name “commodity HHHHH” and tax type information “inclusive tax 10%”, the number of purchased articles “1” and a sale price for the number of purchased articles “228 yen”, and a tag with a tag name “bargain sale target” are displayed. The tag name may be set as “amount and number-of-articles limited price-cut target”. However, since the number of characters increases, the tag name is set as “bargain sale target”. On the registration screen SCn illustrated in FIG. 36, since a total amount of a transaction is 1193 yen and is more than 1000 or more yen, the “amount and number-of-articles limited price-cut” is concluded. However, since the number of purchased articles is “2”, a price of only one article is cut by 60 yen. Accordingly, on the detail list display section ARb, a commodity name “commodity HHHHH” and tax type information “inclusive tax 10%”, the number of purchased articles “2” and a sale price before price-cut “456 yen”, a price-cut amount “-60 yen” and a sales price after price-cut “396 yen”, and a tag with a tag name “bargain sale concluded” are displayed. A deletion line is drawn on the sales price before price-cut “456 yen”. The tag name may be set as “amount and number-of-articles limited price-cut concluded”. However, since the number of characters increases, the tag name is set as “bargain sale concluded”. The tag name may be simply “bargain sale”.

On the registration screen SCn illustrated in FIG. 36, a price of only one article of two purchased articles of the commodity HHHHH is cut. Accordingly, the one article is sold at the discounted sales price of 168 yen but the remaining article is sold at a normal sales price of 228 yen. However, since the registration screen SCj of the information terminal 40 only displays a reference price, in this embodiment, details for many purchased commodities are to be displayed together on the touch panel 44, which has only a small display region, thus certain information may be concatenated, combined, omitted, or the like.

The “number-of-articles limited price-cut” is a sales promotion method involving selling a promotion target commodity at a bargain price (price lower than a normal price) for up to some set number of articles of the target commodity but prohibiting purchasing above the set number of articles. Therefore, in the case of the “number-of-articles limited price-cut”, price-cut conclusion conditions include a code for identifying a target commodity of the “number-of-articles limited price-cut”, a set number of articles, a price-cut amount obtained by subtracting the bargain price from the normal price, and the bargain price. The code may be a commodity code or may be a classification code.

On the registration screen SCn illustrated in FIG. 36, the commodity KKKKK is a target commodity of the “number-of-articles limited price-cut”. Specifically, FIG. 36 illustrates the “number-of-articles limited price-cut” for “selling only one article of the commodity KKKKK having a normal price of 128 yen at a bargain price of 99 yen and not admitting purchase of two or more articles”. That is, on the detail list display section ARb, a commodity name “commodity KKKKK” and tax type information “inclusive tax 8%”, the number of purchased articles “1” and a sales price before price-cut “128 yen”, a price-cut amount “-29 yen” and a sales price after price-cut “99 yen”, and a tag with a tag name “bargain sale concluded” are displayed. The tag name may be set as “number-of-articles limited price-cut concluded”. However, since the number of characters increases, the tag name is set as “bargain sale concluded”. The tag name may be simply “bargain sale”.

Even if a customer scans a barcode of the commodity KKKKK with the camera 45 in order to purchase two or more articles of the commodity KKKKK or performs operation for changing the number of purchased articles from the number-of-articles change screen, an error occurs and the customer cannot perform commodity registration.

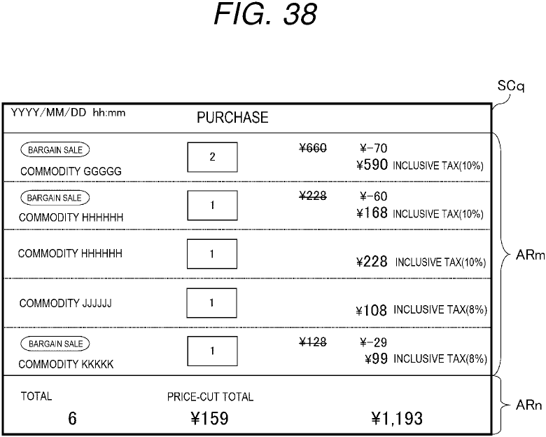

On the registration screen SCn illustrated in FIG. 36, if a price-cut confirmation operation for touching a price-cut total amount displayed on the total display section ARa is performed, the registration screen SC is switched to a concluded price-cut confirmation screen SCp (see FIG. 37). A position touched in the price-cut confirmation operation is not limited to the price-cut total amount. For example, the price-cut confirmation operation may be operation for touching the part of a price-cut total or may be operation for touching a word of good deal information.

FIG. 37 is an example of the concluded price-cut confirmation screen SCp. As illustrated, sections for “good deal information 1,” “good deal information 2,” and “good deal information 3” are displayed in a region ARf of the concluded price-cut confirmation screen SCp.

The “good deal information 1” relates to the “amount designated price-cut”. Specifically, a commodity name “commodity GGGGG” of a price-cut target commodity, the number of purchased articles “2” of a price-cut target, a price-cut amount “-70”, a sales amount before price-cut “660 yen”, and a sales amount after price-cut “590” are displayed together with guidance explaining the “amount designated price-cut” condition(s). A deletion line is drawn on the sales amount before price-cut “660 yen”. The sales amount after price-cut “590 yen” is displayed in a font larger than a font of the other information.

The “good deal information 2” relates to the “amount and number-of-articles limited price-cut”. Specifically, a commodity name “commodity HHHHH” of a price-cut target commodity, the number of purchased articles “1” of a price-cut target, a price-cut amount “-60”, a sales amount before price-cut “330 yen”, and a sales amount after price-cut “270 yen” are displayed together with guidance explaining the “amount and number-of-articles limited price-cut” condition(s). A deletion line is drawn on the sales amount before price-cut “330 yen”. The sales amount after price-cut “270 yen” is displayed in a font larger than a font of the other information. In this way, on the concluded price-cut confirmation screen SCp, information relating to a first article, which is a price-cut target, of a commodity is displayed. Information relating to a second article, which is not a price-cut target, of the same commodity is not displayed.

The “good deal information 3” relates to “number-of-articles limited price-cut”. Specifically, a commodity name “commodity KKKKK” of a price-cut target commodity, the number of purchased articles “1” of a price-cut target, a price-cut amount “-29”, a sales amount before price-cut “128 yen”, and a sales amount after price-cut “99 yen” are displayed together with guidance explaining the “number-of-articles limited price-cut” condition(s). A deletion line is drawn on the sales amount before price-cut “128 yen”. The sales amount after price-cut “99 yen” is displayed in a font larger than a font of the other information.

The customer who confirms the concluded price-cut confirmation screen SCp performs a touch operation the “OK” button BTm. After the touch operation on the “OK” button BTm, the screen of the touch panel 44 returns from the concluded price-cut confirmation screen SCp to the registration screen SCn.

FIG. 38 is an example of a checkout confirmation screen SCq displayed on the display of the POS terminal 23 or the dedicated checkout machine 24. Specifically, the checkout confirmation screen SCq is used when the customer, who is a user of the information terminal 40 on which the registration screen SCn illustrated in FIG. 36 is displayed, performs checkout. As illustrated, the checkout confirmation screen SCq is divided into a transaction detail area ARm and a transaction total area ARn. In the transaction detail area ARm, a commodity name, the number of purchased articles, a sales price, tax type information, and the like are displayed for each of commodities purchased by the customer. A sales price before price-cut and a price-cut amount are displayed about a commodity for which a price-cut is concluded. The sales price is a sales price after price-cut. A deletion line is drawn on the sales price before price-cut. Further, a tag “bargain sale” indicating that the price-cut is concluded is displayed. In the total area ARn, a total number of articles, a total amount, and a total of price-cut amounts are displayed.

Regarding the commodity HHHHH, the number of purchased articles of which is two, there is one article for which a price-cut of the “amount and number-of-articles limited price-cut” is concluded and one article for which the price-cut is not concluded. On the checkout confirmation screen SCq, a record for the one article for which the price-cut is concluded and a record for the one article for which the price-cut is not concluded are separately displayed. Therefore, an operator who confirms the checkout confirmation screen SC q can learn that one article of commodity HHHHH is being sold at a price-cut of 60 yen and the other article of commodity HHHHH is being sold at a normal price. Similarly, the operator can easily learn for the commodity GGGGG for which the price-cut of the “amount designated price-cut” is concluded, that a price-cut of 70 yen is performed for the number of purchased articles of two.

### Modifications

In an embodiment, the smartphone is used as the information terminal 40. In other examples, the information terminal 40 may be a tablet terminal attached to a shopping cart or a portable terminal rent out to a customer by a store.

The commodity registration device is not limited to a mobile information terminal 40 or the like. For example, a self-service type POS terminal with which a customer performs a registration operation and a checkout operation for purchasing commodities having a form corresponding to the information terminal 40 as a commodity registration device. If the described functions of an information terminal 40 are provided by a self-service type POS terminal, then the customers can easily identify items for which a price-cut condition has been met during the registering of items by himself or herself at the self-service type POS terminal.

In an embodiment, a tag is associated with the registered commodity for which the price-cut is concluded and a tag is associated with to the registered commodity for which the price-cut is not yet concluded and these different tags can be distinguished from one another by the character colors (font color) or the like. However, these tags do not necessarily have to be distinguished in this manner. The tags may be distinguished from one another by background colors of characters rather than the character colors or may be distinguished by densities of colors of characters.

In an embodiment, if the message MSa of the concluded price-cut confirmation screen SCg is selected, the unconcluded price-cut confirmation screen SCh is displayed. Timing for displaying the unconcluded price-cut confirmation screen SCh is not limited to this. For example, if the commodity CCCCC for which the [single item price-cut] is not concluded is selected on the registration screen SCf illustrated in FIG. 29, the message MSb of the unconcluded price-cut confirmation screen SCh may be displayed. Similarly, if the commodity DDDDD for which the [bundle sale price-cut] is not concluded is selected, the message MSc of the unconcluded price-cut confirmation screen SCh may be displayed. Consequently, the customer can always check information indicating what conditions remain to be satisfied to conclude a price-cut for a registered commodity for which a price-cut might be available.

In an embodiment, the registration support server 11 transmits the detail response command including the detail data for the number of detail data n saved in the transaction file 51 to the information terminal 40. Concerning this point, the processor 111 of the registration support server 11 may extract detail data in which the update flag Fc is set to “1” and transmit the detail response command including the detail data to the information terminal 40. Consequently, it is possible to reduce a processing load of the detail analysis processing executed by the processor 41 of the information terminal 40.

In an embodiment, as the types of price-cuts, the “M&M price-cut”, the “bundle sale price-cut”, the “single item price-cut”, the “amount designated price-cut”, the “amount and number-of-articles limited price-cut”, and the “number-of-articles limited price-cut” are described. The types of price-cuts are not limited to this. A price-cut may be of any type beyond these or as combinations of these types or others.

As another example of the “amount and number-of-articles limited price-cut”, there is a sales promotion method involving cutting a price of a promotion target commodity by some predetermined price-cut amount for up to some set number of articles every time a total amount of a transaction increases by a set amount. Thus, for example, every time a total amount of the transaction increases by at least 1000 yen a price cut is applied to another article of a price-cut target commodity. That is, in this sales promotion method, if the total amount of the transaction is between 1000 yen and 2000 yen, a price of one article of the price-cut target commodity is cut but if the total amount of the transaction increase to be 2000 yen to 3000 yen, the price two articles of the price-target commodity is cut. In such a sales promotion method, it may preferable that data of a target commodity of such a promotion should be collectively displayed in one detail area in the information terminal 40 but displayed as separate records on the checkout confirmation screen SCp displayed on the display of the POS terminal 23 or the dedicated checkout machine 24.

In an embodiment, the price-cut conclusion conditions relate to a target commodity, the number of articles, and the sales amount after price-cut conclusion. The price-cut conclusion conditions are not limited to this. For example, a price-cut amount at the time when a price-cut is concluded may be included in the price-cut conclusion conditions.

In an embodiment, the total memory 62 includes the area for storing the total number of items Ta, the total amount Tb, and the price-cut total amount Tc. The configuration of the total memory 62 is not limited to this. For example, since the total amount displayed in the total display section ARa of the registration screen is an amount obtained by subtracting the price-cut total amount Tc from the total amount Tb, the total memory 62 may further include an area for storing the total amount after the price-cut.

In an embodiment, the number of articles of the registered commodity to be purchased is changed on the number of articles change screen SCi. In other examples, the number of articles change screen SCi may not be required to change the number of articles of a commodity to be purchased. For example, the number of purchased articles displayed in the detail list display section ARb of the registration screen may be displayed in a cell with a pulldown list and the number of purchased articles may be selected out of the pulldown list. Alternatively, a screen of ten numerical keys may be displayed rather than the number of articles change screen SCi to permit numerical input of the number of purchased articles.

In an embodiment, the camera 45 is stopped in ACT 21, ACT 26, or ACT 46. While the scan screen SCc is not displayed, so long as a barcode cannot be scanned by the camera 45, the camera 45 does not always have to be stopped.

In an embodiment, a commodity registered for purchase is illustrated as an example of a transaction target commodity. However, the transaction target commodity does not always have to be a commodity available for purchase. For example, a commodity that is available for rental (leasing) in a rental shop or the like can also be a transaction target commodity to which a price-cut condition might be applied.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A commodity registration device for a self-service checkout system, the device comprising:
a display screen;
a communication interface connectable to a registration support server; and
a processor configured to:
receive an input of a commodity code identifying an item to be included in a customer transaction;
receive and store commodity detail data from the registration support server, the commodity detail data including a commodity name and a price of the item corresponding to the commodity code;
cause the display screen to display commodity data for items included in the customer transaction in a list format; and
cause the commodity detail data of items in the list format associated with a price-cut condition to be displayed in a distinguishable manner for those items in the list format that are not associated with any price-cut condition.

2. The commodity registration device according to claim 1, wherein those items in the list format associated with a price-cut condition that has been satisfied are further distinguished from those items in the list format associated with a price-cut condition that has not been satisfied.

3. The commodity registration device according to claim 2, wherein tags displayed on the display screen in conjunction with the items in the list format are used to distinguish between items associated with a price-cut condition that has been satisfied and those items associated with a price-cut condition that has not been satisfied.

4. The commodity registration device according to claim 3, wherein the processor is further configured to:
cause the display screen to display details of a price-cut condition associated with an item in the transaction when the tag displayed in conjunction with the item is selected by a user.

5. The commodity registration device according to claim 1, wherein tags displayed on the display screen in conjunction with the items in the list format are used to distinguish between items associated with a price-cut condition and those items not associated with a price-cut condition.

6. The commodity registration device according to claim 5, wherein the processor is further configured to:
cause the display screen to display details of a price-cut condition associated with an item in the transaction when the tag displayed in conjunction with the item is selected by a user.

7. The commodity registration device according to claim 1, wherein the processor is further configured to:
cause the display screen to display a price-cut amount associated with a price-cut condition for an item in the transaction that has been satisfied.

8. The commodity registration device according to claim 1, wherein the processor is further configured to:
cause the display screen to display details of a price-cut condition associated with an item in the transaction when the item is selected from the list format.

9. A commodity registration device, comprising:
an input unit configured to receive an input of a commodity code used to identify a transaction target commodity;
a storing unit configured to store commodity detail data including a commodity name and a price of the transaction target commodity identified using the commodity code;
a display unit configured to display, in a list format, commodity detail data of transaction target commodities in a transaction; and
a control unit configured to cause the display unit to display the commodity detail data of transaction target commodities associated with a price-cut condition to be displayed on the display unit in the list format in a manner distinguishable from the commodity detail data of other transaction target commodities.

10. The commodity registration device according to claim 9, wherein the control unit further causes the display unit to display a price-cut amount upon satisfaction of the price-cut condition for the transaction target commodity.

11. The commodity registration device according to claim 9, wherein, upon receiving a price-cut confirmation instruction after the price-cut condition for the transaction target commodity has been satisfied, the control unit is configured to extract the commodity detail data of the transaction target commodity for which the price-cut was satisfied from the storing unit and cause the display unit to display the extracted commodity detail data.

12. The commodity registration device according to claim 9, wherein the control unit is further configured to cause the display unit to display the commodity detail data of a transaction target commodity for which a price-cut condition has not yet been satisfied among the transaction target commodities in the list format to be distinguishable from the commodity detail data of other transaction target commodities.

13. The commodity registration device according to claim 12, wherein the control unit is further configured to cause the display unit to display information regarding an unsatisfied price-cut condition for the transaction target commodity.

14. A commodity registration method for a self-service checkout system, the method comprising:
receiving an input of a commodity code identifying an item to be included in a customer transaction;
receiving and storing commodity detail data from a registration support server, the commodity detail data including a commodity name and a price of the item corresponding to the commodity code;
causing a display screen to display commodity data for items included in the customer transaction in a list format; and
causing the commodity detail data of items in the list format associated with a price-cut condition to be displayed in a distinguishable manner for those items in the list format that are not associated with any price-cut condition.

15. The commodity registration method according to claim 14, wherein those items in the list format associated with a price-cut condition that has been satisfied are further distinguished from those items in the list format associated with a price-cut condition that has not been satisfied.

16. The commodity registration method according to claim 15, wherein tags displayed on the display screen in conjunction with the items in the list format are used to distinguish between items associated with a price-cut condition that has been satisfied and those items associated with a price-cut condition that has not been satisfied.

17. The commodity registration method according to claim 16, further comprising:
causing the display screen to display details of a price-cut condition associated with an item in the transaction when the tag displayed in conjunction with the item is selected by a user.

18. The commodity registration method according to claim 14, wherein tags displayed on the display screen in conjunction with the items in the list format are used to distinguish between items associated with a price-cut condition and those items not associated with a price-cut condition.

19. The commodity registration method according to claim 18, further comprising:
causing the display screen to display details of a price-cut condition associated with an item in the transaction when the tag displayed in conjunction with the item is selected by a user.

20. The commodity registration method according to claim 14, further comprising:
causing the display screen to display details of a price-cut condition associated with an item in the transaction when the item is selected from the list format.
